(19) United States
(12) Patent Application Publication
(10) Pub. No.: US 2026/0148188 A1
(43) Pub. Date: May 28, 2026

(54) Computer-Automated Order Forecasting System and Method

(71) Applicant: Synkrato Inc., San Ramon, CA (US)

(72) Inventors: Amin Sikander, San Ramon, CA (US); Karun Jain, San Mateo, CA (US); Sury Balasubramanian, Sunnyvale, CA (US); Sandeep Konam, Hyderabad (IN); Anantha Karthik, Chennai (IN); Vinnakota Charumathi, Hyderabad (IN)

(73) Assignee: Synkrato Inc., San Ramon, CA (US)

(21) Appl. No.: 19/358,886

(22) Filed: Oct. 15, 2025

Related U.S. Application Data
(60) Provisional application No. 63/821,544, filed on Jun. 11, 2025.

(30) Foreign Application Priority Data
Nov. 22, 2024 (IN) 202421091062

(51) Int. Cl. G06Q 10/087; G06Q 30/0601

(52) U.S. Cl. CPC G06Q 10/08726; G06Q 30/0635

(57) ABSTRACT

A computer-automated order forecasting system and method is disclosed that provides highly detailed predictions of future orders for warehouse operations. The system receives sales history, demand forecast, and supply chain plan data as inputs, preprocesses the data, and employs advanced time series decomposition techniques to break down the input into trend, seasonality, and residual components. A forecasting module utilizes statistical forecasting, machine learning, and probability sampling to generate predictions for order IDs, specific items, and their quantities for each order per day. The system combines these forecasts to produce a comprehensive predicted order book, enabling more efficient inventory management, labor allocation, and slotting strategies. This granular approach at the SKU-UoM level, coupled with effective handling of noisy warehouse data, allows warehouses to transition from reactive to proactive operations, improving overall performance and reducing costs.

### CROSS-REFERENCE TO RELATED APPLICATIONS

This application claims the benefit of priority of Indian Patent Application number 202421091062 filed Nov. 22, 2024, and U.S. Provisional Patent Application No. 63/821,544 filed Jun. 11, 2025, the contents of which are all incorporated herein by reference in their entirety.

### BACKGROUND

Order forecasting is a critical component of efficient warehouse and supply chain management. Accurate predictions of future orders allow businesses to optimize inventory levels, labor allocation, and overall operational efficiency. However, traditional demand planning and forecasting methods often fall short in providing the granular level of detail required for effective warehouse operations.

Existing planning engines typically focus on calculating aggregate demand for SKUs at an enterprise or warehouse level. While this broad view is useful for high-level supply chain planning, it fails to address the specific needs of day-to-day warehouse management.

Warehouse operators require more detailed information, such as the expected number of orders, the composition of those orders, and the specific units of measure for each SKU.

The limitations of current forecasting methods lead to several challenges in warehouse operations, such as:
Inefficient inventory management: Without accurate predictions of order composition and frequency, warehouses struggle to maintain optimal stock levels, leading to either stockouts or excess inventory.
Suboptimal labor allocation: Lack of detailed order forecasts makes it difficult to accurately predict labor requirements, resulting in either understaffing or overstaffing.
Ineffective slotting strategies: Without granular predictions of order patterns, warehouses cannot optimize the placement of items to minimize picking times and improve overall efficiency.
Inability to adapt to market changes: Traditional forecasting methods often fail to capture and respond to rapid shifts in demand patterns, leaving warehouses reactive rather than proactive.
Difficulty in long-term planning: Existing systems struggle to provide accurate long-term forecasts, hindering strategic decision-making for warehouse operations and expansion.

These challenges are further compounded by the inherently noisy nature of warehouse data, which makes it difficult to identify true trends and patterns using conventional forecasting techniques.

As a result, there is a pressing need for an advanced order forecasting system that can provide highly detailed, accurate predictions at the warehouse level, while also effectively handling the complexities and variabilities inherent in warehouse operations.

### SUMMARY

A computer-automated order forecasting system and method is disclosed that provides highly detailed and accurate predictions of future orders for warehouse operations. The system includes an input module that receives sales history data, demand forecast data, and supply chain plan data. A preprocessing module filters business days, fills missing values, and splits data into training and test sets. The system employs a time series decomposition module that breaks down the input data into trend, seasonality, and residual components, enabling more precise analysis and forecasting.

A forecasting module utilizes a combination of statistical forecasting, machine learning, and probability sampling techniques to generate predictions for five key aspects of order forecasting: number of unique order IDs per day (R0), total number of orders per day (R1), number of unique item IDs per day (R2), item IDs for a given day (R3), and quantities of items for a given day (R4)

The forecasting module employs various models such as Auto ARIMA, Auto Gluon, Prophet, and Neural Prophet, selecting the best combination based on performance metrics.

An order book generation module combines the forecasts from R0-R4 to produce a final predicted order book, which provides a comprehensive view of expected orders, including the number of orders, specific items, and their quantities for any given forecasting horizon.

This system offers several advantages over traditional planning engines. For example, it provides granular predictions at the SKU-UoM (Stock Keeping Unit-Unit of Measure) level, enabling more efficient warehouse operations. It also effectively handles noisy warehouse data through advanced time series decomposition techniques. Furthermore, it enables dynamic inventory management by adapting to changing order patterns and market conditions. In addition, it improves long-term strategic planning capabilities for warehouse operations.

The order forecasting system may integrate with existing automated slotting systems (such as the system 100 shown in FIG. 1) to enhance overall warehouse efficiency, optimize inventory management, and reduce operational costs. For example, the predicted order book data 322 generated by the order forecasting system may be provided as input to the simulator 104 of the slotting system, allowing the slotting system to generate slotting strategies based on forecasted order patterns rather than relying solely on historical data or simulated order books. This integration is facilitated by the shared use of sales history data, which serves as input data 302 for the order forecasting system and as sales history data 152 for the slotting system's product affinities engine 108, creating a unified data ecosystem where the same historical sales patterns inform both systems' operations.

By providing accurate and detailed predictions of future order compositions, the system enables warehouses to transition from reactive to proactive operations, leading to improved labor allocation, more effective slotting strategies, and better overall performance.

Other features and advantages of various aspects and embodiments of the present invention will become apparent from the following description and from the claims.

### BRIEF DESCRIPTION OF THE DRAWINGS

FIG. 1 is a diagram of a computer-automated slotting system implemented according to one embodiment of the present invention.

FIG. 2 is a flowchart of a method performed by the system of FIG. 1 according to one embodiment of the present invention.

FIG. 3 is a high-level dataflow diagram illustrating a computer-automated order forecasting system according to one embodiment of the present invention.

FIG. 4 is a flowchart of a method performed by the system of FIG. 3 according to one embodiment of the present invention.

### DETAILED DESCRIPTION

A computer-automated system performs slotting optimization based on inputs such as any one or more of the following: sales history, Advanced Shipment Notices (ASNs), picking history, current inventory, pick history, demand forecast, location placement, and multiple warehouse configuration parameters (e.g., slotting rules configurable by the user). Based on those inputs, the system detects product affinities, builds a predictive order book, and accounts for re-slotting costs and runs through multiple simulations to generate a slotting plan. The system receives feedback on its outputs and learns based on that feedback, thereby continuously improving the slotting recommendations that it generates.

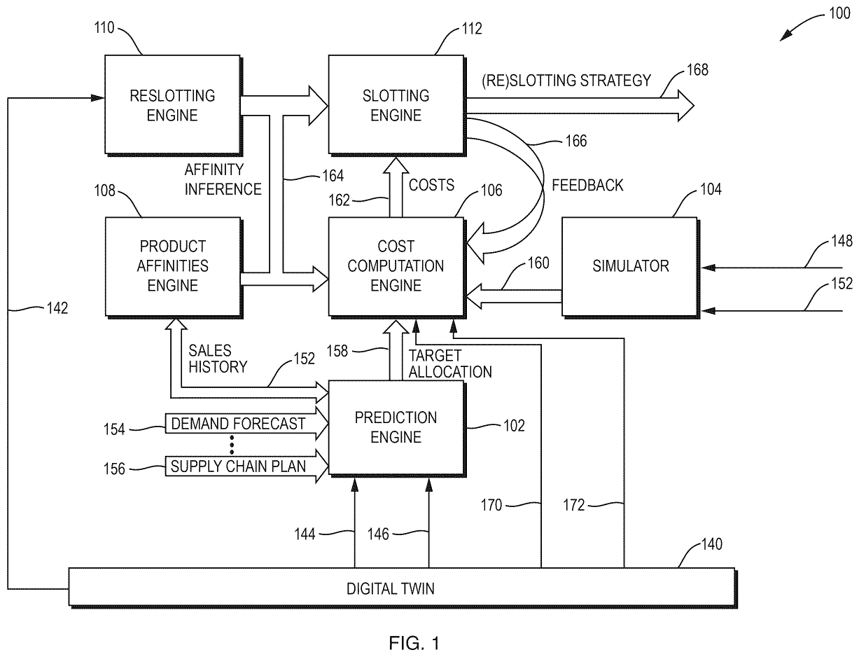

Referring to FIG. 1, a diagram is shown of a computer-automated slotting system 100 implemented according to one embodiment of the present invention. The system 100 may be used to assist with slotting in any kind of physical space, such as a warehouse or other facility. As a result, any reference herein to a particular kind of facility, such as a warehouse, should be understood to be applicable more generally to any kind of facility or other physical space.

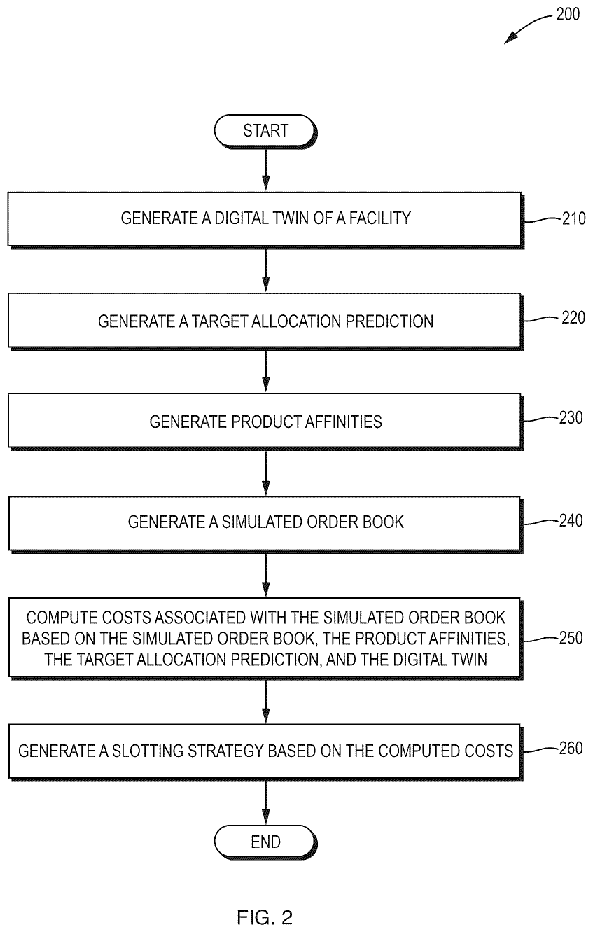

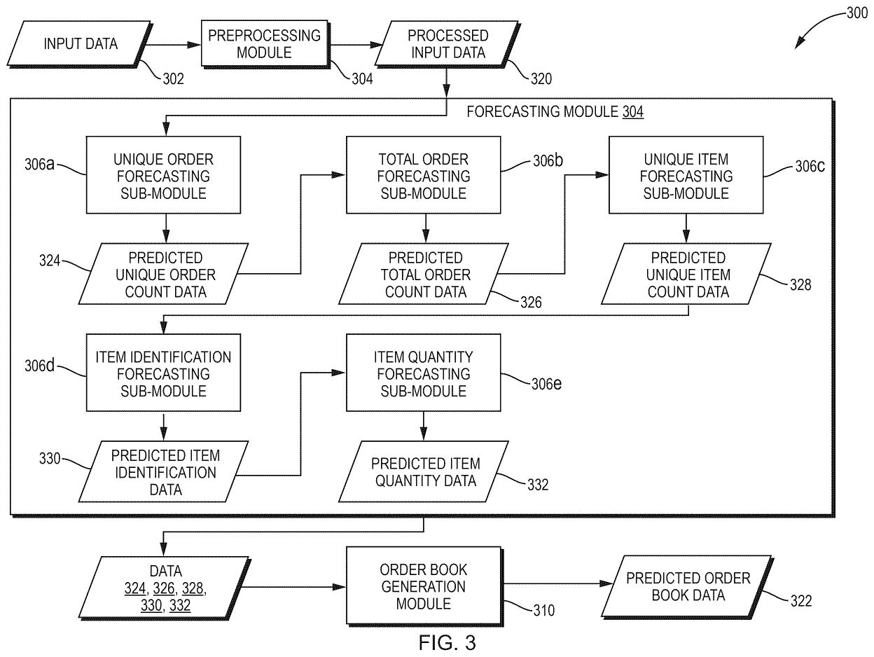

The system 100 includes a predictive engine 102, which generates a target allocation 158 (FIG. 2, operation 220). The predictive engine 102 may, for example, receive any one or more of the following as inputs, and generate the target allocation 158 based on such inputs: sales history data 152, demand forecast data 154, a supply chain plan 156, one or more Advanced Shipping Notices (ASNs) 144, and one or more inventory entries 146. The predictive engine 102 may also incorporate forecasted demand patterns from an order forecasting system (such as the system 300 shown in FIG. 3) when generating the target allocation 158, allowing the predictive engine 102 to account for predicted future order patterns in addition to historical data. The sales history data 152 serves as a foundational data source that creates a unified data ecosystem by feeding both the product affinities engine 108 within the slotting system and serving as input data 302 for the order forecasting system, enabling historical sales patterns to inform both current slotting decisions and future order predictions. The demand forecast data 154 and supply chain plan 156 may be received, for example, from an Enterprise Resource Planning (ERP) system. The demand forecast data 154 may, for example, be an output of a demand planning engine, which is used to forecast aggregate demand by time period (e.g., quarter or year) based on pastilles, promotions being run, etc. The supply chain plan 156 may, for example, represent a plan for fulfilling the demand represented by the demand forecast data 154, such by using internal manufacturing capabilities or by buying from outside vendors. The ASNs 144 may be used to solidify supply chain plan inputs, as these are actual scheduled inbound materials. The inventory entries 146 may, for example, be used for FIFO calculations.

The target allocation 158 may include data representing a prediction of an optimal SKU_UoM allocation. (In the context of warehouse slotting, “SKU” refers to Stock Keeping Unit, and “UoM” refers to Unit of Measure. A “SKU_UoM” is a particular SKU:UoM combination. A “SKU_UoM” allocation is an allocation of SKU_UoMs.) The target allocation 158 may, for example, be a vector having the same dimensionality m as the total number of SKU_UoMs, where m is the number of SKU_UoMs that are to be allocated inside the warehouse or other facility:

$$Q = [ Q 1 , Q 2 , … , Qm ]$$

In this vector, Qi is the quantity of the ith SKU_UoM that is to be allocated inside the warehouse.

The various types of data described above, may for example, include the following:
Sales history data 152: any one or more of order ID, transaction date, item ID, SKU_UoM, and transaction quantity for each sale.
Demand forecast data 154: any one or more of item ID, SKU_UoM, period of demand, and quantity of demand predicted for each item.
Supply chain plan 156: any one or more of item ID, SKU_UoM, quantity of item, and relevant date(s) (e.g., manufacturing completion date, promised date) for each item.
Advanced shipping notices (ASNs): any one or more of order ID, item ID, SKU_UoM, SKU_UoM quantity, ASN expected date, actual shipment date, and actual receipt date for each item.
Inventory entries: any one or more of item ID, SKU_UoM, item quantity, and date of entry (e.g., receipt date, manufacturing completion date) for each receipt of inventory at the warehouse.
External data that may impact the demand for an item such as weather, macro-economic trends, housing starts, commodity futures, interest rates, inflation

An ASN is a notification sent (often electronically) to a customer or consignee in advance of a shipment's arrival. It provides details about the shipment, such as the quantity, type of products, expected arrival time, carrier information, and more.

The ASN can facilitate smoother receiving processes at the warehouse or distribution center by allowing the recipient to prepare for the shipment's arrival. It helps in planning the labor and space required for unloading, inspecting, and storing the incoming goods, and it can also be used to cross-reference the delivered items with the purchase order to ensure accuracy. Overall, the ASN is an essential tool in modern supply chain management, enhancing communication and efficiency between trading partners.

The system 100 (e.g., the cost computation engine 106 described below) may use one or more order books as input. Such order books may be actual or predicted (simulated) order books. It may be useful to use simulated order books if the actual order books to be fulfilled are not known. The system 100 may include a simulator 104, which may, for example, receive sales data (such as an actual order book 148 and/or the sales history data 152) as input and generate, based on that input, a simulated order book 160 (FIG. 2, operation 240). Alternatively or additionally, the simulator 104 may receive predicted order book data (such as the predicted order book data 322 generated by the order forecasting system 300 shown in FIG. 3) as input, allowing the simulator 104 to incorporate forecasted order patterns when generating the simulated order book 160. The order book 160 may, for example, include data representing predictions of the average number and type of orders that will have to be fulfilled on a day to day basis. The simulator 104 may be executed any number of times to generate any number of simulated order books. The system 100 may minimize the average cost of fulfillment across a plurality of order books generated by the simulator 104. Note that although the following description refers to the use of the order book 160 output by the simulator 104, any function that is described herein as being performed using the order book 160 may instead be performed using an actual (non-simulated) order book or a predicted order book generated by an order forecasting system.

The sales history data 152 may include, for example, for each of a plurality of sales, any one or more of the following: a transaction date of the sale, an item ID of the item sold in the sale, a SKU_UoM of the item sold in the sale, a quantity of the item sold in the sale, and an Order ID of the sale. The simulator 104 may, for example, understand the underlying pseudorandomness of sales data (e.g., the order book 148 and/or sales history data 152) within a particular period of time (e.g., one year) and generate the order book 160 based on that sales data. The order book 160 may, for example, include any one or more of the following: the number of orders, the number of distinct items in each order, the type(s) of items (e.g., item IDs) in each order, and the quantities of each distinct item in each order.

For example, the simulator 104 may use a sophisticated statistical approach to analyze the uncertainty and randomness in the sales history data 152. By understanding how that uncertainty is distributed across different aspects of the orders and applying principles from probability theory, the simulator 104 can create the order book 160 to reflect likely future orders in the warehouse. In particular, the simulator 104 may use a distributed entropy-based bootstrapping sampler which separates the potential sources of (conditional) uncertainty in a sequential manner. This sampler may work across different parts or sources of information and take into account various factors, such as product types, affinities, and seasonality. The sampler may take into account entropy in the sales history data 152, e.g., how uncertain or random different aspects of the sales history data 152 are. The bootstrapping aspect of the sampler may draw repeated samples from the sales history data 152 to make inferences from that data. The sampler may analyze the uncertainty related to different aspects of the orders in the sales history data 152 (e.g., product demand, order size) one by one, in a specific sequence. By doing so, it can consider how uncertainty in one area might affect or be affected by uncertainty in another.

The simulator 104 may extend the (conditional) chain rule of probability to distribute the entropy of randomness and use that to create the order book 160. As is well-known, the conditional chain rule allows for the calculation of joint probabilities by breaking them down into a series of conditional probabilities. The simulator 104 may apply the conditional chain rule to distribute the uncertainty across different aspects of the simulated orders in the order book 160. The dependencies of various aspects of simulated orders may be made conditionally independent via the chain rule for entropy. The simulator 104 may apply the statistical principles described above to understand the randomness inherent in the sales history data 152 and use that understanding to generate realistic data in the order book 160.

The system may employ hyperparameter tuning to optimize key parameters of the sampling process. Finding the best set of weights and other parameters, such as sampling window size, may be accomplished through hyperparameter tuning to maximize prediction accuracy. The sampling window determines the size of the historical transaction bins created around specific dates, while the weights control the relative importance given to different time periods in the sampling process.

The system 100 also includes a cost computation engine 106. The cost computation engine 106 may, for example, receive any one or more of the following as inputs: the target allocation 158, an order book (e.g., an actual order book, the simulated order book 160 output by the simulator 104, or predicted order book data from an order forecasting system), an affinity inference 164, the architecture of the warehouse, the warehouse picking policy, the warehouse batching policy, and any feedback 166. The cost computation engine 106 may generate costs 162 as output, based on such inputs (FIG. 2, operation 250). When the cost computation engine 106 receives predicted order book data from an order forecasting system, it may calculate expected fulfillment costs based on forecasted order patterns, enabling proactive cost optimization rather than reactive adjustments. This may include incorporating forecasted order volumes, item combinations, and seasonal variations into cost calculations, allowing the cost computation engine 106 to anticipate cost fluctuations and optimize warehouse operations based on predicted demand patterns rather than relying solely on historical or simulated data. The feedback 166 from the slotting engine 112 may incorporate accuracy metrics from order forecasting predictions, including comparisons between actual fulfilled orders and predicted orders to assess forecasting performance and identify areas for improvement in both slotting strategies and forecasting models. The warehouse architecture that the cost computation engine 106 receives as input may, for example, be an actual architecture of the warehouse or the digital twin 140 of the warehouse described elsewhere herein. The costs 162 may, for example, include the total fulfillment cost of an order book (e.g., the order book 160 output by the simulator 104 or predicted order book data from an order forecasting system). The cost computation engine 106 may, for example, include two components: a computation component and an estimation component.

The cost computation engine 106 may, for example, receive any one or more of the following as inputs:
A digital map 172 of the warehouse, which may contain, for example, labeled XY coordinates of the entire warehouse (from the top view) and locations of slot IDs on the above coordinates, including the types of slots.
UoM conversion (i.e., the quantity of a SKU in a particular UoM).
Scales of horizontal and vertical movements, and the relative ratio between costs of horizontal movement and costs of vertical movement for a given unit distance.
Various policies and parameters 170 associated with the warehouse, such as the picking policy of the Warehouse Management System (WMS), the batching policy of the WMS, any slotting parameters, any resource allocation/limitation of the warehouse (e.g., SKU/zone restrictions), any algorithms that govern the batching of order books, and equipment information.

The cost computation engine 106 may minimize the cost to fulfill daily orders based on the current structure of the warehouse in any of a variety of ways. This cost may be computed based on the overall fulfillment and replenishment costs of the warehouse. The cost computation engine 106 may perform bilevel optimization to perform such cost minimization. Bilevel optimization in this context means that the cost computation engine 106 operates at two distinct hierarchical levels. At the upper level, strategic decisions are made concerning the overall management of warehouse resources, such as determining optimal inventory levels and setting broad slotting strategies. These decisions aim to minimize long-term operational costs and enhance the efficiency of the warehouse. At the lower level, the cost computation engine 106 focuses on operational decisions that directly impact daily activities, such as the specific allocation of tasks for order fulfillment and the scheduling of inventory replenishment. These decisions are made within the constraints and objectives set by the upper-level strategy, ensuring that daily operations align with the broader goals of the warehouse. Decisions at the lower level may provide feedback to the upper level, informing adjustments to strategies based on real-world outcomes and performance metrics. Conversely, the strategic framework established at the upper level may guide the optimization processes at the lower level, ensuring that daily operations contribute to the overarching objectives of cost minimization and operational efficiency.

By implementing bilevel optimization, the cost computation engine 106 effectively balances long-term planning with the agility needed for day-to-day operations, leading to a more cost-effective and responsive warehouse management system. This approach not only reduces the overall fulfillment and replenishment costs but also enhances the adaptability of the warehouse to changing demands and operational conditions.

Consider the following example in the context of a candy warehouse managing five specific SKUs—Skittles, Sour Patch Kids, Gummy Bears, M&Ms, and Nerds. At the upper level, the primary focus is on managing restock costs and prioritizing inventory replenishment based on demand patterns. For instance, if Skittles and Nerds experience higher demand compared to the other SKUs, the optimization model prioritizes their restocking. This strategic decision-making process involves analyzing sales data, forecasting demand, and calculating the cost implications of various restocking strategies. By prioritizing the replenishment of high-demand items, the warehouse can ensure a steady supply of these products, thereby minimizing potential sales losses due to stockouts and optimizing the use of financial resources allocated for inventory procurement.

Once the strategic decisions regarding restocking are set at the upper level, the lower level optimization takes over to handle the operational aspect of SKU distribution within the warehouse. The objective here is to arrange the units of each SKU in a manner that maximizes order fulfillment efficiency and minimizes handling costs. Given the high demand for Nerds and Skittles, the optimization model might place these items closer to the exit or in more accessible locations. This strategic placement reduces the travel time and effort required for picking these items, thereby speeding up the order fulfillment process and reducing labor costs.

The integration of upper and lower level optimizations forms a cohesive strategy that the cost computation engine 106 may use to address both the macro-level inventory management and micro-level operational efficiency. This bilevel approach allows the warehouse to dynamically adjust its strategies based on real-time data and changing market conditions. By aligning the restocking priorities with the most efficient distribution and storage strategies, the warehouse can significantly reduce the overall costs associated with inventory management and order fulfillment.

Embodiments of the present invention may use the following parameters and variables when performing bilevel optimization:
N: Total number of sections in the warehouse.
M: Total number of SKUs managed within the warehouse.
x_ij: Binary variable indicating whether SKU i can be placed in section j.
n_j: Number of slots available in section j.
sl_j: Total slots in section j.
cap_ij: Capacity of any slot in section j for SKU i.
d_i: Expected demand for SKU i over the planning horizon.
rsg_i: Restocking cost for SKU i.
eq_i: Steady-state inventory level for SKU i.
q_ij: Number of units of SKU i that fit in section j.

The upper-level optimization may focus on determining the optimal inventory levels (eq_i) for each SKU to minimize restocking costs, which are influenced by expected demand (d_i). The objective function at this level may calculate the total restocking costs by considering the proportion of products needed in the inventory and their associated restocking costs. This function is dependent on the outcomes of the lower-level optimization, forming a nested structure where the upper level sets the constraints and goals for the lower level.

Constraints that may be taken into account by the bilevel optimization process include:
The sum of products in each section equals the total number of products, ensuring that inventory levels are maintained across the warehouse.
The ratio of the number of SKUs per section to the capacity must not exceed the total number of slots available in each section.

The lower-level optimization aims to minimize the costs associated with arranging SKUs in the warehouse to efficiently fulfill orders. This involves calculating the expected cost of fulfilling an order, selected from a distribution of possible orders, given the SKU arrangement determined by the upper-level decisions. The goal is to find the most cost-effective arrangement of SKUs that facilitates quick and efficient order processing.

The combined optimization objective of the bilevel optimization process is to minimize the sum of the costs of fulfilling orders and the costs of restocking. This may be achieved by integrating the decisions from both levels, e.g.:
The lower level finds the minimum cost of fulfilling an order based on the SKU arrangement.
The upper level determines the optimal inventory levels to minimize restocking costs.

The overall system may strive to achieve the minimum combined cost, balancing order fulfillment efficiency with inventory management effectiveness. By implementing this bilevel optimization approach, embodiments of the present invention may dynamically adjust to changes in demand and operational conditions, ensuring optimal performance and cost efficiency.

The system 100 also includes a product affinities engine 108. Product affinity refers to the relationship between different products based on customer buying patterns and behavior. By analyzing historical sales data and transaction records (e.g., the sales history data 152), the product affinities engine 108 can identify patterns and correlations between products that are frequently purchased together or have a high likelihood of being purchased together, and generate an affinity inference 164 (FIG. 2, operation 230). The product affinities engine 108 may receive the sales history data 152 and, based on that sales history 152, analyze product affinities within the sales history 152, and generate the affinity inference 164 to quantify such product affinities. The same sales history data 152 that feeds the product affinities engine 108 also serves as input data 302 for the order forecasting system 300, creating a unified data ecosystem where historical sales patterns inform both current slotting decisions through product affinity analysis and future order predictions through forecasting models. In particular, the affinity inference 164 may represent relationships between different items based on their co-occurrence and, in particular, frequency of co-occurrence in orders.

The product affinities engine 108 may generate the affinity inference 164 in any of a variety of ways. For example, the product affinities engine 108 may use a quasi-Bayesian approach, in which the product affinities engine 108 assumes that the entire order book consists of samples from a well-defined pseudo-random “order generator.” The product affinities engine 108 may not assume that items in a particular order are independent of each other, but may instead try to mathematically quantify how items within the order book 160 are related to each other based on the order book 160. The resulting affinity inference 164 may, for example, include data representing cause-and-effect relationship within the affinities identified by the product affinities engine 108, such as the antecedent (cause), consequent (effect), confidence (a measure of how strong or reliable the identified relationship between products is), and average ratio.

The affinity inference 164 may represent the quantities above in the form of nodal graphs, where the nodes of the graphs contain the quantities and the edges of the graphs have the confidence values associated with the nodes connected by those edges. For example, if two nodes represent two products, an edge connecting those two nodes may contain a confidence value representing a confidence that the two products co-occur within an order. The average ratio may convey that for every quantity of antecedent, the consequent quantity is X times the antecedent quantity.

Consider, for example, a graph having a Node A representing the antecedent and a Node B representing the consequent. Assume that the Node A contains an order ID of the antecedent and that Node B contains an order ID of the consequent, and that there is a directed edge from Node A to Node B, having an associated confidence value. The direction of the edge from Node A to Node B corresponds to an affinity between the antecedent and the consequent only when the antecedent is brought into the warehouse. Also associated with Node A and Node B may be average ratio values obtained by finding the average ratios of antecedent-consequent pairs in the entire order book. For example, if the average ratio value associated with Node A is X and the average ratio value associated with Node B is Y, then every time a quantity of X of the antecedent is bought, then a quantity of Y of the consequent is bought in the same order, on average. As a particular example, if X=1 and Y=1.25, then on average, whenever 1 of the antecedent is bought, then 1.25 of the consequent is bought.

The system 100 also includes a reslotting engine 110, which receives the current inventory 142 of the warehouse and the costs 162 as input, and which generates reslotting strategies (i.e., strategies for rearranging items within slots in the warehouse) in order to reduce costs related to storing and retrieving items by placing them in more optimal locations within the warehouse. The goal of the reslotting engine 110 is to generate reslotting strategies that are profitable even when taking into account the added costs that would be incurred by implementing such reslotting strategies. A reslotting strategy 168 may, for example, be generated by the reslotting engine 110 and contain data representing a list of current and suggested optimal locations in which to slot items in the warehouse.

The system 100 also includes a slotting engine 112, which receives as input the costs 162, the affinity inference 164, and the output of the reslotting engine 110 and generates, based on those inputs, the slotting strategy 168 (FIG. 2, operation 260). The slotting strategy 168 may, for example, contain data representing a slot-wise allocation of SKU_UoMs and quantities. When the system 100 is integrated with an order forecasting system, the slotting engine 112 may utilize predicted order book data to generate slotting strategies that are optimized for anticipated future order patterns, rather than relying solely on historical data. This integration allows the slotting engine 112 to proactively position items based on forecasted demand, improving overall warehouse efficiency. The slotting engine 112 may also generate the feedback 166 to the cost computation engine 106, which may include accuracy metrics derived from comparing actual fulfilled orders against predicted orders from the order forecasting system, enabling continuous refinement of both slotting strategies and forecasting models through a closed-loop improvement process.

The reslotting engine 110 and/or slotting engine 112 may, for example, receive any one or more of the following inputs:
for each of a plurality of items to be slotted, the item ID, item dimensions (e.g., length, width, and/or height), and the item UoM;
labelled XY coordinates of the entire warehouse (from the top view);
aisle/slot locations based on the above coordinates;
types of slots available at the warehouse;
for each type of slot, one or more dimensions of the slot (e.g., any one or more of slot length, slot height, and slot width)
slot locations in the warehouse and their respective slot type;
one or more picking and batching policies of the WMS;
current inventory of items in the warehouse, e.g., for each item UoM, the item ID, slot ID, and quantity of the item.

The reslotting engine 110 and/or slotting engine 112 may generate the reslotting strategy and the slotting strategy 168 in any of a variety of ways. For example, for any given order book, the reslotting engine 110 and slotting engine 112 may work with a superset S of all possible configurations, with the goal of discovering the configuration having the lowest cost in the set S. (A configuration is a specific arrangement or layout of items within the warehouse that is associated with a particular set of cost.) However, the order book is not fully known. As a result, the reslotting engine 110 and/or slotting engine 112 may perform processing on expected costs of order books, rather than on deterministic (e.g., actual) costs of order books. This may be done, for example, by using the simulator 104 to generate multiple predictions/simulations of the order book for the upcoming fulfillment cycle, and attempting to find a configuration that minimizes the aggregated costs over all of these order books In this optimization process, occupancy/sparsity and the list of order books (over which we are trying to minimize costs) may together act as a fulfillment constraint.

The cardinality of the set S may be reduced by imposing an upper bound on it, thereby making it sparse. However, the reduced set would still be beyond exponential in terms of number of slots and items. As a result, even this reduction in cardinality does not reduce the computational complexity of the problem.

As described above, the predictive engine 102 may generate the target allocation 158, and the simulator 104 may perform simulations to generate the order book 160. These may be particularly useful if the order book to be fulfilled is not known (or is not fully known). Additionally, the system 100 may integrate with an order forecasting system (such as the system 300 shown in FIG. 3) to receive predicted order book data, which can supplement or replace simulated order books generated by the simulator 104. However, if the order book to be fulfilled is fully known in advance, then embodiments of the present invention may generate the slotting strategy 168 without the predictive engine 102 and the simulator 104, and without generating the target allocation 158 and the order book 160.

For example, the system 100 may perform a method which analyzes the order book to be fulfilled over a specific period of time, without using the predictive engine 102 or the simulator 104. Such a method may perform item-wise summation of the order book over a windowed function of item, i.e., generate a sum, for each SKU in the order book, the quantity of that SKU that have been ordered. Such a sum may be calculated during a particular time period, such as over the past week, month, or year. This method identifies the total demand for each item (SKU) at the level of the warehouse within the particular window of time.

Embodiments of the present invention may create, store, and update a virtual representation, or “digital twin,” of an existing warehouse (FIG. 2, operation 210). This digital twin 140 is a highly sophisticated tool that provides a detailed, three-dimensional representation and view of the warehouse, aiding in the precise and automated slotting of items. The digital twin 140 may also incorporate real-time updates from order fulfillment activities, tracking inventory movements and picking patterns that provide valuable data for refining forecasting models in integrated order forecasting systems. Embodiments of the present invention may receive information about an existing warehouse (e.g., one or more 3D models of the warehouse) and generate the digital twin 140 based on that information. The digital twin 140 may mirror the actual warehouse's layout and features, allowing for comprehensive visualization and analysis.

More specifically, embodiments of the present invention may use 3D modeling technology to engage in a rack design phase, which may include constructing virtual racks, aisles, rows, and zones in the digital twin. Input values, such as dimensions, materials, and specific requirements may be used to ensure that the digital twin 140 accurately reflects the physical warehouse's storage components. A specialized grid drawing system may be employed to meticulously build the floor of the digital warehouse. This includes the detailed layout of different zones, rows, racks, and aisles, mirroring the exact organization of the physical space of the actual warehouse.

Embodiments of the present invention may dynamically create the walls and ceiling within the digital twin. These algorithms may consider the warehouse's actual size and shape, generating these components in a way that is true to the real-world structure. One of the innovative features of embodiments of the present invention is their ability to integrate pre-existing, or “already built,” 3D models into the digital twin's representation of the warehouse space. For example, through a simple drag-and-drop functionality, users may place these models at various locations within the digital twin, enhancing the realism and functionality of the virtual environment. As another example, embodiments of the present invention may automatically place already-built 3D models into the digital twin's representation of the warehouse. Embodiments of the present invention may provide tools that allow users to modify one or more parameters of an already-built 3D model. For example, users may use such tools to adjust the size of a storage rack or the position of partitions within a model

By creating this detailed digital twin, embodiments of the present invention facilitate automated slotting processes within the warehouse in any of the ways disclosed herein. The digital twin 140 may not be a static entity; embodiments of the present invention may continue to store and update the digital twin 140 to reflect any changes within the actual physical warehouse. Additionally, the digital twin 140 may capture and analyze real-time order fulfillment activities, including inventory movements, picking patterns, and operational workflows, which can then feed back into integrated order forecasting systems to improve prediction accuracy and model refinement. Examples of changes that embodiments of the present invention may use to trigger corresponding changes in the digital twin 140 include one or more of the following:
Inventory Changes: Any changes in inventory levels, such as new stock arrivals, stock depletion, or adjustments due to audits, may trigger an update in the digital twin 140 to reflect current inventory status accurately. As another example, movements of items within the warehouse, whether temporary or permanent, may be mirrored in the digital twin 140 to maintain an accurate layout of physical stock locations.
Operational Modifications: Updates to operational processes or workflows, such as changes in picking strategies or the introduction of new packing methods, may be reflected in the digital twin 140 to simulate and analyze the impact of these changes on warehouse operations. Integration of new technologies or upgrades to existing systems, such as automated guided vehicles (AGVs) or conveyor belt systems, may be incorporated into the digital twin 140 to assess their operational efficacy and spatial requirements.
Physical Layout Adjustments: Any structural changes to the warehouse, such as the addition or removal of walls, expansion of storage areas, or reconfiguration of aisles, may be updated in the digital twin 140 to ensure it accurately represents the physical space. Modifications made to enhance safety, such as changes in emergency exit routes or updates to comply with new health and safety regulations, may be promptly reflected in the digital twin 140.
Resource Allocation: Changes in the allocation or deployment of resources, including machinery, labor, and storage equipment, may be updated in the digital twin 140 to optimize resource planning and utilization. Scheduled maintenance or unexpected downtime of equipment may be updated in the digital twin 140 to facilitate real-time planning and adjustments to warehouse operations.

In response to any of these changes, embodiments of the present invention may update the digital twin 140 automatically to enable it to remain current, thereby providing a continually accurate and valuable tool for warehouse management.

Furthermore, embodiments of the present invention enable users to quickly and easily build the digital twin 140 of the warehouse without prior knowledge of the underlying technology by enabling such digital twins to be constructed using a user-friendly drag-and-drop user interface that enables digital twins to be constructed from cuboids. Users may easily create racks of specific sizes and types, and can replicate those racks throughout an entire row.

Embodiments of the present invention may include a powerful search functionality that connects directly with the inventory backend information (i.e., information about the current inventory of the warehouse, such as the IDs and locations of items in the warehouse) in the digital twin 140. This allows users to easily locate specific items or materials within the digital twin 140 of the warehouse. By querying the detailed inventory data, users can find information about the exact location, quantity, and characteristics of items in real time, making it easier to plan and manage storage and retrieval operations.

Embodiments of the present invention offer the capability to modify the appearance of the 3D models within the digital twin 140 by altering the shader (a module that dictates how surfaces of objects within the digital twin 140 are rendered). Such modifications may include, for example, outlining versions of the materials, which may be used to highlight specific items or areas within the virtual warehouse. For example, high-priority goods or items that require special handling might be visually emphasized using this feature.

Embodiments of the present invention may maintain an open connection (socket) to listen for changes that occur on one or more associated web platforms, such as one or more Internet of Things (IoT) and/or RFID devices that can be associated with a product, equipment, or a person to track movement in real-time and reflect such movement in the digital twin 140. This may, for example, include updates from other systems, notifications from sensors, or input from users working on different devices. When any such change is detected, embodiments of the present invention may respond in real time, updating the digital twin 140 to reflect that change. This ensures that the digital twin 140 is always synchronized with the actual warehouse's current state and with other changes. The real-time data captured through these connections may also feed into integrated order forecasting systems, providing current operational insights that improve the accuracy of future order predictions and enable more responsive forecasting model adjustments. For example, if an item's inventory level changes or a new shipment is recorded in a connected system, this information may be automatically reflected in the digital twin, thereby enabling accurate and up-to-the-minute slotting and other decision-making.

These additional functionalities further elevate the digital twin's value as a tool for modern warehouse management. The integration of inventory backend information provides direct insights into the status and location of goods within the digital environment. The ability to modify the appearance of 3D models enhances visual communication and understanding, and the real-time synchronization through an opened socket ensures that the digital twin 140 is constantly aligned with the actual conditions in the warehouse. The digital twin's comprehensive tracking of inventory movements, picking patterns, and operational metrics creates a rich data source that can significantly enhance order forecasting accuracy when integrated with predictive systems. Together, these features create a dynamic, interactive, and highly effective platform for managing and optimizing warehouse operations.

Embodiments of the present invention may use a 3D development platform, such as the Unity engine from Unity Technologies. Such a 3D development platform may be leveraged to enable developers to create complex and interactive 3D models of a warehouse for the digital twin. For example, Unity offers various functionalities, including physics engines, rendering capabilities, and a wide range of built-in components that can be used to model real-world behavior within the virtual environment. Embodiments of the present invention may use Object Oriented Programming (OOP) methodology to obtain the fullest potential of the 3D development platform's component workflow.

To ensure seamless communication with the backend services, embodiments of the present invention may implement an Application Program Interface (API), such as a REST (Representational State Transfer) API. This API acts as a bridge, enabling the exchange of information between the digital twin 140 and other backend systems, such as the inventory management system. The use of a REST API ensures standardized communication and allows for the real-time updating of information, such as inventory levels, product details, and warehouse configurations.

Embodiments of the present invention may include a user interface element, also referred to herein as an “information panel,” which displays pertinent data about the warehouse's status, inventory, and operations. The backend services feed this information to the information panel, thereby keeping users informed about and engaged with the digital twin.

Embodiments of the present invention may use a pathfinding algorithm, such as the A* (A star) pathfinding algorithm, which is a popular and widely-used algorithm in computer science for finding the shortest path between nodes in a graph. It has applications in various domains, including video games, robotics, and network routing. Examples of other pathfinding algorithms including Dijkstra's Algorithm, the Bellman-Ford Algorithm, Greedy Best-First Search, and Jump Point Search. Embodiments of the present invention may use any pathfinding algorithm to calculate the most efficient paths for moving items within the warehouse, considering various factors like distances, coordinates, and time consumed. In the context of slotting plan functionality, a pathfinding algorithm (such as the A* algorithm) may be used to aid in determining optimal storage locations for items, taking into account the warehouse layout, item characteristics, and other constraints. This ensures that the slotting plan is both efficient and effective. By optimizing the distances and routes, embodiments of the present invention may help to minimize the time and effort required for various warehousing activities, such as picking, placing, and replenishing items.

In summary, embodiments of the present invention may integrate cutting-edge programming methodologies, interactive design features, and intelligent algorithms to create a sophisticated and dynamic digital twin 140 of the warehouse. By harnessing the power of Object-Oriented Programming, Unity's capabilities, REST API communication, and A* pathfinding, embodiments of the present invention may offer a comprehensive and versatile tool for modern warehouse management, enhancing visualization, decision-making, and overall efficiency.

The reslotting engine 110 and slotting engine 112 may generate the slotting strategy 168 in any of a variety of ways. For ease of explanation, the following description will refer to the slotting engine 112 as generating the slotting strategy 168, although in practice the slotting strategy 168 may be generated by the reslotting engine 110 and/or the slotting engine 112.

The slotting engine 112 may model the warehouse (using the digital twin) as a union of cuboids, and may treat each floor in the warehouse as a 2D array containing a plurality of shelves. A “section” of the digital twin 140 is a collection of slots. The digital twin 140 may include a plurality of sections. Within each section, all of the slots are standardized (e.g., all of the slots have the same dimensions, such as length, width, and/or height). Slots in different sections, however, may have different dimensions. The plurality of sections do not intersect, and the union of the plurality of sections equals the entire warehouse, as modeled by the digital twin.

Embodiments of the present invention may allow the digital twin 140 of the warehouse to include one or more “bulk locations,” where a bulk location is defined as an area in the warehouse that is assumed to be able to accommodate all types of slots.

Embodiments of the present invention may measure the cost of traveling (“travel cost”) from one slot to another based on the distance between those slots, measured in the manner just described. More generally, embodiments of the present invention may use costs as a proxy for distance. As a result, cost minimization may imply minimization of a summation of the relevant distances. Examples of types of costs that the cost computation engine 106 may calculate and use as proxies for distance include:
Picking Costs: The costs associated with the process of retrieving (“picking”) items from their storage locations in the warehouse to fulfill orders. This is a critical aspect of warehouse operations, especially in facilities that handle a high volume of orders. Picking costs may include for example, labor costs, equipment costs, error costs, energy costs, and/or impact of picking on other operations. Embodiments of the present invention can work with varying picking costs across slots. This would also make the algorithm applicable to “Golden Areas” which may have lesser picking costs in the warehouse compared to other slots.
Travel Costs: The costs associated with traveling from one location to another within the warehouse.
Dropping Costs: Time necessary to drop off items at a destination locator—e.g., offloading items from fork lift/pallet jack and physically placing them in the rack.
Replenishment Costs: The costs associated with replenishing a particular SKU_UoM into a slot in the warehouse. Each SKU_UoM may have an associated replenishment cost. Different SKU_UoMs may have different associated replenishment costs.

The cost computation engine 106 may calculate any of the costs described above and include the resulting calculated costs in the costs 162. Any of a variety of changes associated with the warehouse may cause the costs 162 calculated by the cost computation engine 106 to change. For example, if the technology of the warehouse changes or expands (e.g., a new escalator or new intra-floor conveyor is installed in the warehouse), then the cost computation engine 106 may update its calculations of the costs 162 to reflect such changes to the warehouse. As another example, if a new wall is constructed or removed in the warehouse, this may alter travel costs and/or dropping costs in the warehouse, and the cost computation engine 106 may update its calculations of the costs 162 to reflect such changes to the warehouse.

In the context of warehouse operations, an “order book” refers to a comprehensive record or ledger containing all the orders that a warehouse has received. These orders typically come from customers or other parts of the business and represent requests for specific goods to be shipped or delivered. Examples of the contents of an order book include the following:
Order Details: This includes information about each order, such as the products requested, quantities, order date, requested delivery date, customer details, shipping address, and any special instructions.
Status Tracking: The order book may also track the status of each order as it moves through various stages of processing, picking, packing, shipping, and delivery. This helps in coordinating different parts of the warehouse operation and provides visibility into the status of outstanding orders.
Priority Handling: Orders might be prioritized in the order book based on factors like delivery deadlines, customer importance, or the nature of the goods. This can guide the order in which items are picked and shipped.
Integration with Other Systems: The order book may be part of a larger Warehouse Management System (WMS) or Enterprise Resource Planning (ERP) system, allowing it to integrate with other aspects of the business, such as inventory management, shipping, and billing.

An order book may be divided into batches. Such grouping into batches may be based, for example, on factors such as order priority, delivery location, and product type. Each batch represents a collection of orders that will be handled together. Such batches may, for example, be of equal size. The batches may, for example, be fulfilled sequentially across batches.

A warehouse “batching policy” is the method or strategy used to group orders into batches for more efficient processing within the warehouse. This is a part of the warehouse's overall order fulfillment strategy, which aims to optimize the picking, packing, and shipping processes. Batching policies can vary based on the specific needs and priorities of the warehouse, but they generally focus on grouping orders in a way that maximizes efficiency and minimizes costs, such based on order similarity, order priority, order size, equipment and labor utilization, shipping considerations, and a desire to align with the warehouse picking strategy. By implementing an effective batching policy, a warehouse can significantly improve the efficiency and accuracy of its operations, reducing costs and enhancing customer satisfaction.

“Processing” a batch involves dividing the fulfilled batch across different shelves, sections, or aisles and allocating specific tasks to the picking staff. This is a more detailed step that organizes how the fulfilled orders will be handled within the warehouse. It may involve things like sorting the items for final packaging, labeling, or assigning specific orders to specific workers or teams.

After a batch is processed, it is “fulfilled,” which means that the items for all the orders within that batch have been collected, packed, and are ready for shipment. Fulfillment is the overall process of getting the ordered items from their storage locations and preparing them for delivery to the customers. It includes everything from picking the items off the shelves to packing them in shipping boxes.

A warehouse may have a picking policy. A picking policy is a set of rules or strategies that govern how items are selected and retrieved from their storage locations in the warehouse. Different policies may prioritize efficiency, accuracy, speed, or other factors. Common picking policies might include wave picking, zone picking, or batch picking. A picking policy may, for example, follow a First In First Out (FIFO) strategy, with the assumption that the SKU_UoMs that are slotted first are fulfilled first if they are available at more than one location in the warehouse.

Each batch may be further divided based on the aisles where the items are located into “aisle orders.” Such division may be performed in accordance with the warehouse's picking policy (such as the FIFO strategy). The information about which items to pick from each aisle is made available to the relevant personnel or systems for every batch. This helps to coordinate the picking process across different parts of the warehouse.

A “stage” is a designated area where picked items are gathered, organized, and prepared for the next step in the fulfillment process, such as packing or shipping. Bringing items to the stage is part of the process of getting them ready to leave the warehouse. The picking policy deployed by the warehouse determines the way in which specific products (SKU_UoMs) in the required quantities are collected and prepared (brought to the stage) to fulfill the orders in each batch. Hence, the total cost of fulfillment operations is a function of the order book, the warehouse picking policy, the warehouse batching policy, and the warehouse structure.

Each warehouse typically has a “main stage,” which is a central area or hub within the warehouse where items are collected, processed, or staged after being picked from the aisles. The main stage is a designated space that acts as a connecting point or common area where items from different aisles are brought together for further processing, such as packing, sorting, or shipping.

As one example of an embodiment of the present invention, consider the following test case, in which every aisle in the warehouse has a designated area at the bottom, called the “aisle stage” for that aisle, which serves as a temporary holding or staging area for items that have been picked from that aisle. To get items from the slots (shelves) in the aisle to the aisle stage, vertical movement is used, meaning items are moved straight down to the aisle stage area. The aisle stage in each aisle can be accessed from the main stage (central area) of the warehouse using only horizontal movements. This separation of vertical and horizontal movements aids in efficient navigation and handling within the warehouse.

In this particular example, after receiving communication about what to pick from each aisle, the staff pick the required items and move them vertically downward to the aisle stage of that aisle, in readiness for further movement. Once all such vertical picking has been completed in the aisles, the warehouse staff transitions to the horizontal picking stage, in which all items held in the respective aisle stages of the aisles are moved solely horizontally to the main stage. This final step consolidates all picked items in the main stage (central area), where they can be further processed (e.g., packed and shipped). However, embodiments of the present invention are able to scale beyond the above-mentioned warehouse staging policy and picking policy.

The example process above represents a methodical and structured approach to picking that leverages the physical layout of the warehouse to maximize efficiency. By separating the picking process into vertical and horizontal stages and utilizing dedicated staging areas at the end of each aisle, the warehouse can streamline the movement and handling of items, potentially reducing the time and effort required to fulfill each order.

To accommodate the above-described warehouse geometric model, different types of costs, and various aspects of warehouse operations, embodiments of the present invention may use a modular slotting system of the kind shown in FIG. 1.

One of the advantageous features of embodiments of the present invention is their ability to continuously learn and improve based on user feedback and performance metrics. By receiving feedback on its outputs, including accuracy metrics from order forecasting predictions that compare actual fulfilled orders against predicted orders, the system is able to identify areas of improvement and refine its slotting recommendations. This adaptive learning process creates a continuous improvement loop between the slotting system and order forecasting system, where forecasting accuracy metrics inform slotting strategy adjustments, and actual fulfillment performance data helps refine forecasting models. This bidirectional feedback ensures that the system constantly enhances its performance, resulting in increasingly accurate and effective slotting plans and more precise order predictions.

In order to generate the most optimal slotting plan, embodiments of the present invention may run through multiple configurations and use such simulations to take into consideration various factors, such as re-slotting costs, warehouse parameters, and user-defined slotting rules when generating slotting recommendations. By evaluating different scenarios, the system is able to compare the efficiency of each plan, ultimately providing the most cost-effective and streamlined solution.

Embodiments of the present invention may be used to produce significant improvements in efficiency and cost reduction for warehouse operations. By maximizing product accessibility, minimizing travel distances, and optimizing storage capacity, the system may be used to ensure that inventory management becomes more streamlined and cost-effective.

Instead of relying on manual labor to determine the most efficient placement of inventory items within the warehouse, embodiments of the present invention may be used to automate the slotting process. By analyzing historical sales data, order patterns, and other relevant factors, embodiments of the present invention intelligently identify the optimal locations for each item in the warehouse.

For example, consider a retail company that offers a wide range of products, from small accessories to large appliances. Traditionally, warehouse employees would spend a significant amount of time manually organizing and reorganizing the inventory to ensure efficient storage and retrieval. This process not only required a substantial labor force but also led to errors and inefficiencies due to human limitations.

By using embodiments of the present invention, such a retail company may eliminate the need for manual slotting entirely by automatically calculating the optimal placement for each item based on sales data, product characteristics, and other relevant factors. This not only reduces labor costs associated with slotting but also minimizes the risk of errors and improves overall operational efficiency.

Furthermore, embodiments of the present invention provide flexibility and adaptability. As a business grows or changes its product mix, embodiments of the present invention may easily adjust the slotting strategy to accommodate new items or changes in demand patterns. This eliminates the need for costly and time-consuming physical reconfigurations of the warehouse layout.

A company that uses an embodiment of the present invention to perform slotting may significantly reduce upfront capital investments. A software-based solution that implements an embodiment of the present invention may leverage existing infrastructure and only require a computer system with sufficient processing power. This makes it accessible and affordable for businesses of all sizes, from small startups to large enterprises.

Embodiments of the present invention may generate a predictive order book: a forecast of the orders that will typically be fulfilled in a particular period of time. This ability provides a variety of benefits, such as:
Improved Inventory Management: By forecasting the orders that will typically be fulfilled, the warehouse can manage inventory levels more efficiently. This ensures that there is enough stock to meet anticipated demand without overstocking, which would tie up capital and potentially lead to obsolescence.
Enhanced Supply Chain Coordination: With a predictive view of future orders, coordination with suppliers can be optimized. This means timely reordering, negotiating better terms with suppliers, and aligning production schedules if manufacturing is involved.
Better Resource Allocation: Knowing in advance what orders are likely to come in helps in planning the labor and equipment needed to process those orders. This can lead to more efficient scheduling and utilization of resources, reducing operational costs.
Reduction in Stockouts and Overstocks: Accurate predictions help in maintaining the right balance of inventory, reducing the chances of stockouts (where an item is unavailable) or overstocks (where too much of an item is kept). This helps in maintaining customer satisfaction and reduces holding costs.
Strategic Planning Support: Forecasting the order book can be a vital tool for long-term strategic planning. It can guide decisions on warehouse expansion, technology investments, partnerships with suppliers, and other strategic initiatives.
Risk Mitigation: Predictive analytics can also identify potential risks in the supply chain, such as dependence on a single supplier for a critical item. By foreseeing potential challenges, steps can be taken to mitigate these risks before they become issues.
Agility in Responding to Market Changes: With a clear understanding of future demand, a warehouse can be more agile in responding to market trends and changes. If a sudden surge or drop in demand is predicted, the warehouse can respond quickly to capitalize on opportunities or minimize losses.

Embodiments of the present invention may generate slotting recommendations which take reslotting costs into account, and which attempt to minimize such reslotting costs. This ability provides a variety of benefits, such as:
Cost Efficiency: Reslotting can be an expensive and labor-intensive process. Minimizing these costs can lead to significant savings, allowing resources to be allocated elsewhere in the warehouse.
Optimized Space Utilization: Proper slotting ensures that products are placed in the most efficient locations within the warehouse. This optimal use of space can increase the capacity of the warehouse and make material handling more efficient.
Reduced Labor Costs: By minimizing the need for reslotting, the warehouse can reduce the labor costs associated with moving products from one location to another. This can also reduce the risk of worker fatigue and related injuries.
Improved Picking Efficiency: Slotting that takes into account the frequency and co-occurrence of picks can reduce travel time for pickers. This leads to faster order fulfillment and can have a positive impact on customer satisfaction.
Increased Agility and Responsiveness: By continually analyzing and adjusting slotting to minimize reslotting costs, the warehouse becomes more agile and can respond more quickly to changes in order patterns or inventory levels.
Inventory Optimization across warehouses in a network: By forecasting for every warehouse accurately in a network, embodiments of the invention may not only reduce the stock outs at these warehouses but also decrease transfer costs involved in moving product from one warehouse to another to fulfill customer demand

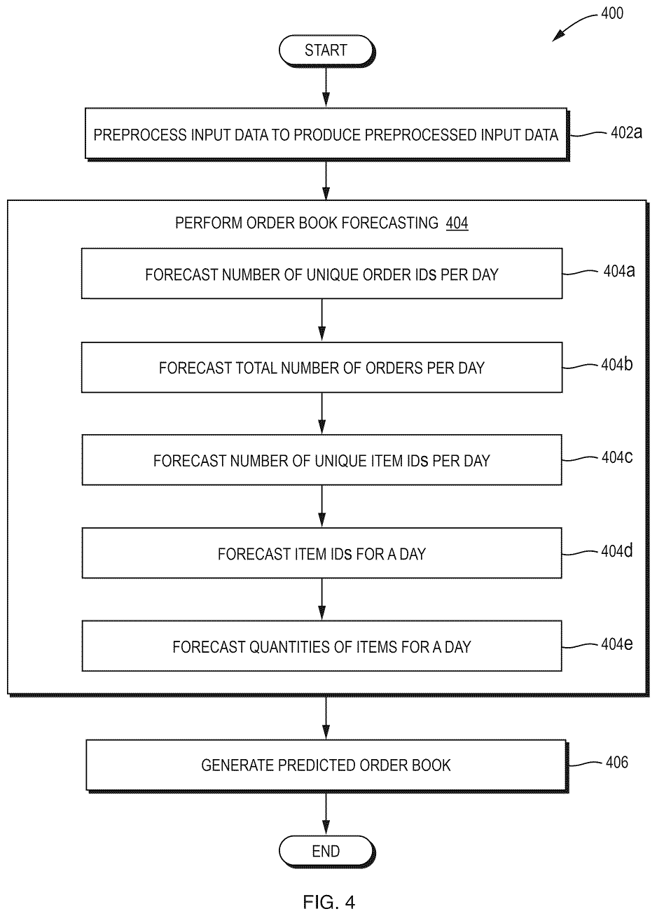

Referring to FIG. 3, a diagram is shown of a computer-automated order forecasting system according to one embodiment of the present invention. optimization system 300 implemented according to one embodiment of the present invention. Referring to FIG. 4, a flowchart is shown of a method 400 that is performed by the system 300 of FIG. 3 according to one embodiment of the present invention.

Embodiments of the order forecasting invention, as shown in FIGS. 3 and 4, represent a significant advancement in warehouse management and supply chain optimization. This computer-automated system and method addresses the critical need for highly detailed and accurate predictions of future orders, enabling warehouses to transition from reactive to proactive operations.

Embodiments of the order forecasting system process various inputs, including sales history, demand forecast, local economic indicators and supply chain plan data, to generate comprehensive predictions of future order patterns. Unlike traditional planning engines that focus on aggregate demand at an enterprise level, embodiments of the order forecasting invention provide granular forecasts at the SKU-UoM (Stock Keeping Unit-Unit of Measure) level, offering unprecedented insights into expected order compositions.

The system, as illustrated in FIG. 3, employs time series decomposition techniques and a combination of statistical forecasting, machine learning, and probability sampling to generate detailed predictions. These predictions encompass various aspects of order forecasting, including the number of unique orders, total orders, specific items, and their quantities for any given forecasting horizon.

The method performed by the system, outlined in FIG. 4, enables warehouses to optimize multiple facets of their operations. By providing accurate predictions of order patterns, the method facilitates more efficient inventory management, reducing the risk of stockouts or excess inventory.

Embodiments of the order forecasting invention also enhance labor allocation by allowing warehouses to accurately predict staffing needs based on anticipated order volumes and complexities. Furthermore, embodiments of the order forecasting invention significantly improve slotting strategies. By understanding future order compositions in detail, warehouses can optimize the placement of items to minimize picking times and improve overall efficiency. This capability integrates seamlessly with existing automated slotting techniques, such as those shown in FIGS. 1 and 2, creating a powerful synergy that enhances overall warehouse performance.

One of the key benefits of embodiments of the order forecasting invention is the ability to handle the inherently uncertain nature of warehouse data. Through decomposition and forecasting techniques, the system can identify true trends and patterns, providing more reliable long-term forecasts. This capability is particularly valuable for strategic decision-making, enabling warehouses to plan for future growth and adapt to changing market conditions more effectively.

In summary, embodiments of the order forecasting invention represent a transformative approach to warehouse management. By providing highly detailed, accurate predictions of future orders, it empowers warehouses to optimize their operations, reduce costs, and improve overall performance. This system marks a significant step forward in the evolution of supply chain management, offering a powerful tool for businesses seeking to thrive in an increasingly competitive and dynamic marketplace.

The system 300 includes a preprocessing module 304, which receives input data 302 as its input and preprocesses the input data 302 to produce preprocessed input data 320 (FIG. 4, operation 402). The input data 302 may, for example, include any one or more of the following:
sales history data, such as any one or more of order ID, transaction date, item ID, SKU_UoM, and transaction quantity for each sale, which may be the same sales history data 152 that feeds the product affinities engine 108 in the slotting system, creating a unified data ecosystem where historical sales patterns inform both current slotting decisions and future order predictions;
demand forecast data; such as any one or more of item ID, SKU_UoM, period of demand, and quantity of demand predicted for each item; and/or
supply chain plan data, such as any one or more of item ID, SKU_UoM, quantity of item, and relevant dates (e.g., manufacturing completion date, promised date) for each item.

The input data 302 may also include economic indicators, such as credit availability, exchange rate, and inflation rates, which help improve prediction accuracy. Such economic data may, for example, sourced from any of a variety of authoritative databases and institutions, such as any one or more of the following: market interest rates from DNB (De Nederlandsche Bank), credit availability metrics from World Bank, labor and economic indicators from IMF (International Monetary Fund), and inflation data from CBS (Central Bureau of Statistics). This economic data may be merged with the order history data according to their corresponding date-time format to create a comprehensive dataset for training the forecasting models. The integration of economic indicators as covariates enables the system to account for broader market conditions when generating predictions.

The system 300 includes a preprocessing module 304, which receives input data 302 as its input and preprocesses the input data 302 to produce preprocessed input data 320 (FIG. 4, operation 402). The input data 302 may, for example, include any one or more of the following:
sales history data, such as any one or more of order ID, transaction date, item ID, SKU_UoM, and transaction quantity for each sale, which may be the same sales history data 152 that feeds the product affinities engine 108 in the slotting system, creating a unified data ecosystem where historical sales patterns inform both current slotting decisions and future order predictions;
demand forecast data; such as any one or more of item ID, SKU_UoM, period of demand, and quantity of demand predicted for each item; and/or
supply chain plan data, such as any one or more of item ID, SKU_UoM, quantity of item, and relevant dates (e.g., manufacturing completion date, promised date) for each item.

The input data 302 may include economic indicators, such as credit availability, exchange rate, and inflation rates, which help improve prediction accuracy. Such economic data may, for example, sourced from any of a variety of authoritative databases and institutions, such as any one or more of the following: market interest rates from DNB (De Nederlandsche Bank), credit availability metrics from World Bank, labor and economic indicators from IMF (International Monetary Fund), and inflation data from CBS (Central Bureau of Statistics). This economic data may be merged with the order history data according to their corresponding date-time format to create a comprehensive dataset for training the forecasting models. The integration of economic indicators as covariates enables the system to account for broader market conditions when generating predictions.

The preprocessing module 304 may receive additional contextual data that enhances the forecasting accuracy of the system 300. Such additional contextual data may include seasonal adjustment factors that account for recurring patterns in order volumes, such as holiday shopping periods, end-of-quarter business cycles, or industry-specific seasonal variations. The preprocessing module 304 may also receive promotional data indicating planned marketing campaigns, discount periods, or product launches that could significantly impact order patterns. Furthermore, the input data 302 may include external market data such as competitor pricing information, industry trend indicators, and consumer sentiment indices that provide broader context for demand fluctuations.

The preprocessing module 304 may receive operational constraint data from the warehouse management system, including capacity limitations, labor availability schedules, and equipment maintenance windows. This operational data enables the forecasting system to generate predictions that are not only accurate but also operationally feasible within the constraints of the warehouse environment. Additionally, the input data 302 may include customer segmentation data that categorizes orders by customer type, geographic region, or business relationship, allowing the system to generate more targeted forecasts for different customer segments.

The quality and completeness of the input data 302 directly impacts the accuracy of the predicted order book data 322 generated by the system 300. The preprocessing module 304 may implement data validation routines to identify and flag potential data quality issues, such as missing values, outliers, or inconsistent formatting. The module may also perform data enrichment processes that supplement the core input data with derived metrics, such as order velocity trends, item popularity rankings, and customer ordering frequency patterns, thereby providing a more comprehensive foundation for the forecasting algorithms.

The preprocessing module 304 may any of a variety of preprocessing steps on the input data 302 to produce the preprocessed input data 320, such as any one or more of the following:
Filtering business days: The preprocessing module 304 may isolate data pertaining to business days, ensuring that the analysis focuses on relevant operational periods.
Filling missing values: The preprocessing module 304 may address any gaps in the input data 302 using appropriate techniques. For example, a window approach may be used to calculate averages within specific time frames to estimate missing values for business days.

Additionally, the preprocessing module 304 integrates the economic indicator data with the order history data by:
Computing the change in economic indicators across dates to also explain certain patterns
Merging the processed economic data according to their corresponding date-time
format
Aligning economic indicators (credit availability, exchange rates, inflation) with the order history timeline
Time-delayed derivates of economic indicators
Preparing the integrated dataset for splitting into training and test sets

These preprocessing steps help to ensure the quality and reliability of the data used in subsequent stages of the forecasting process. The resulting preprocessed input data 320 provides a clean, properly formatted dataset that combines historical order information with relevant economic indicators, which lays the groundwork for more accurate and meaningful analysis in the later stages of the system 300 and method 400.

The preprocessing module 304 may receive operational constraint data from the warehouse management system, including capacity limitations, labor availability schedules, and equipment maintenance windows. This operational data enables the forecasting system to generate predictions that are not only accurate but also operationally feasible within the constraints of the warehouse environment. Additionally, the input data 302 may include customer segmentation data that categorizes orders by customer type, geographic region, or business relationship, allowing the system to generate more targeted forecasts for different customer segments.

The quality and completeness of the input data 302 directly impacts the accuracy of the predicted order book data 322 generated by the system 300. The preprocessing module 304 may implement data validation routines to identify and flag potential data quality issues, such as missing values, outliers, or inconsistent formatting. The module may also perform data enrichment processes that supplement the core input data with derived metrics, such as order velocity trends, item popularity rankings, and customer ordering frequency patterns, thereby providing a more comprehensive foundation for the forecasting algorithms.

The preprocessing module 304 may perform any of a variety of preprocessing steps on the input data 302 to produce the preprocessed input data 320, such as any one or more of the following:
Filtering business days: The preprocessing module 304 may isolate data pertaining to business days, ensuring that the analysis focuses on relevant operational periods.
Filling missing values: The preprocessing module 304 may address any gaps in the input data 302 using appropriate techniques. For example, a window approach may be used to calculate averages within specific time frames to estimate missing values for business days.
Data normalization and standardization: The preprocessing module 304 may normalize numerical values to ensure consistent scales across different data types, preventing any single variable from dominating the forecasting models due to scale differences.
Outlier detection and treatment: The preprocessing module 304 may identify and handle statistical outliers that could skew forecasting results, using techniques such as interquartile range analysis or z-score methods to detect anomalous data points.
Data aggregation and granularity adjustment: The preprocessing module 304 may aggregate data at appropriate time intervals (daily, weekly, monthly) based on the forecasting horizon requirements and business needs.
Feature engineering: The preprocessing module 304 may create derived features from raw data, such as rolling averages, seasonal indicators, day-of-week effects, and lag variables that capture temporal dependencies in order patterns.

The preprocessing module 304 may integrate the economic indicator data with the order history data by performing any one or more of the following:
Computing the change in economic indicators across dates to also explain certain patterns
Merging the processed economic data according to their corresponding date-time format
Aligning economic indicators (credit availability, exchange rates, inflation) with the order history timeline
Time-delayed derivatives of economic indicators
Creating lagged versions of economic indicators to capture delayed effects on order patterns, recognizing that economic changes may not immediately impact ordering behavior
Calculating moving averages and volatility measures of economic indicators to smooth out short-term fluctuations and identify underlying trends
Normalizing economic indicators to account for different scales and units of measurement across various economic metrics
Preparing the integrated dataset for splitting into training and test sets

The preprocessing module 304 may implement data quality assurance measures, such as any one or more of the following: cross-validation checks between different data sources to identify inconsistencies, temporal consistency verification to ensure chronological order integrity, and completeness assessments to quantify data coverage across different time periods and product categories. The preprocessing module 304 may employ statistical techniques to assess data distribution characteristics and identify potential biases that could affect forecasting accuracy.

These preprocessing steps help to ensure the quality and reliability of the data used in subsequent stages of the forecasting process. The resulting preprocessed input data 320 provides a clean, properly formatted dataset that combines historical order information with relevant economic indicators, which lays the groundwork for more accurate and meaningful analysis in the later stages of the system 300 and method 400.

The system 300 includes a forecasting module 306, which receives the preprocessed input data 320 as input and performs order book forecasting on the preprocessed input data 320 to produce predicted order book data 322 as output (FIG. 4, operation 404).

The forecasting module 306 is designed to generate detailed and actionable forecasts that enhance efficient warehouse management. Unlike traditional planning engines that focus primarily on calculating aggregate demand for SKUs, the forecasting module 306 provides comprehensive predictions that address the specific needs of modern warehouse operations. The operation of the forecasting module 306 will now be described in more detail.

The forecasting module 306 includes an order count forecasting sub-module 306a, which receives the preprocessed input data 320 as input and performs forecasting step R0 on this data to produce predicted order count data 324 (FIG. 4, operation 404a). Forecasting step R0 (operation 404a) is designed to predict the number of orders per day.

The order forecasting sub-module 306a may perform operation 404a as follows. The preprocessed input data 320 may contain the number of orders per time period along with economic indicators that serve as covariates (features) in the forecasting models, where the time period may be, for example, a day, a week, a month, a quarter, or any other suitable time interval. The order count forecasting sub-module 306a may divide the preprocessed input data 320 into separate datasets for training the forecasting models and testing their accuracy. The training data may be decomposed into three components:
A trend component: This represents long-term changes or patterns in the data that occur over an extended period. It captures the overall direction or movement of the time series, showing whether the data is generally increasing, decreasing, or remaining stable over time. Examples of such extended periods may include, but are not limited to, months, quarters, years, or multi-year periods.
A seasonality component: This component captures recurring patterns or fluctuations that occur at regular intervals within the time series data. These patterns typically repeat at fixed periods, such as daily, weekly, monthly, or yearly cycles, depending on the nature of the data being analyzed.
A residual component: This component represents the random fluctuations or noise in the time series data that remain after the trend and seasonality components have been extracted. It captures the irregular variations that cannot be attributed to either long-term trends or recurring seasonal patterns.

Such decomposition into the trend, seasonality, and residual components may be performed, for example, using built-in STL (Seasonal and Trend decomposition using LOESS) decomposition tools. STL decomposition may utilize locally weighted scatterplot smoothing (LOESS) regression to separate time series data into its constituent components. The STL algorithm may iteratively apply smoothing operations to extract the seasonal component first, followed by the trend component, with the residual component representing the remaining variation after removing both seasonal and trend effects. This decomposition allows for a more nuanced analysis of the time series data, enabling the forecasting system 300 to identify and model different aspects of the data separately. In some cases, the order count forecasting sub-module 306a may apply different forecasting models to each decomposed component, allowing for specialized treatment of trend patterns, seasonal variations, and irregular fluctuations. The decomposition process may enhance forecasting accuracy by enabling the forecasting system 300 to capture complex temporal patterns that might be obscured when analyzing the raw time series data as a single entity.

The sub-module 306a may forecast the trend component using any of a variety of forecasting models, such as any one or more of Auto ARIMA, Auto Gluon, Prophet, and Neural Prophet. For example, Auto ARIMA may automatically determine the optimal parameters for autoregressive integrated moving average models by testing different combinations of autoregressive terms, differencing operations, and moving average terms. As another example, Auto Gluon may employ automated machine learning techniques to fit and select among multiple model types including linear models, tree-based models, and neural networks for time series forecasting. Prophet, for example, may decompose time series into trend, seasonal, and holiday components using a generalized additive model framework that handles missing data and outliers robustly. Neural Prophet may extend the Prophet framework by incorporating neural network components for capturing complex non-linear patterns and interactions between different time series components.

The sub-module 306a may forecast the seasonality component using, for example, cyclic picking, in addition to any of the tools described above in connection with trend forecasting. For example, cyclic picking may involve identifying and extracting recurring patterns that occur at regular intervals such as daily, weekly, monthly, or yearly cycles based on historical order patterns. As another example, the seasonality component forecasting may employ Fourier series decomposition to capture multiple overlapping seasonal patterns of different frequencies, such as both weekly and monthly seasonality effects occurring simultaneously. The seasonality forecasting may also utilize seasonal decomposition techniques such as X-13ARIMA-SEATS or STL decomposition to isolate seasonal effects from trend and irregular components.

The sub-module 306a may forecast the residual component using, for example, sampling from a probability distribution of residuals. For example, the residual forecasting may involve fitting a probability distribution such as a normal distribution, t-distribution, or empirical distribution to the historical residuals and then sampling from this fitted distribution to generate future residual values. As another example, the residual component forecasting may employ bootstrap resampling techniques where historical residual values are randomly sampled with replacement to create new residual sequences that preserve the statistical properties of the original residuals. The residual forecasting may also utilize Monte Carlo simulation methods to generate multiple possible residual scenarios based on the estimated probability distribution parameters. Multiple bootstrap samples may be taken and averaged. For example, the sub-module 306a may generate hundreds or thousands of bootstrap samples of residual values and compute the mean across all samples to reduce variance in the final forecast. As another example, the averaging process may involve weighted averaging where more recent residual samples receive higher weights to better reflect current market conditions and operational patterns.

The order forecasting sub-module 306a may use multiple forecasting models to predict the trend and seasonality components of the time series data. Different models may exhibit varying levels of performance for these components. To optimize forecasting accuracy, the sub-module 306a may implement a selection process to identify the most effective combination of models. This selection process may include the following steps:
The sub-module 306a generates predictions using various forecasting models for both the trend and seasonality components.
The predicted values from different model combinations are aggregated.
These aggregated predictions are then compared against the actual historical values.
To quantify the performance of each model combination, the sub-module 306a may utilize an error metric such as the Mean Absolute Percentage Error (MAPE). MAPE provides a measure of prediction accuracy that is independent of the scale of the data, making it suitable for comparing forecast performance across different models and time series. Other error metrics may also be used, such as Mean Absolute Error (MAE), Root Mean Square Error (RMSE), and/or Mean Squared Error (MSE).
Based on the error metric results, the sub-module 306a identifies and selects the combination of models that exhibits the lowest error for forecasting the trend and seasonality components.

This approach allows the unique order forecasting sub-module 306a to leverage the strengths of multiple forecasting techniques while mitigating their individual weaknesses. By systematically evaluating and selecting the optimal model combination, the sub-module 306a can generate more accurate and reliable forecasts of unique order counts, even when dealing with the complex and noisy data typically encountered in warehouse management scenarios.

The integration of economic indicators as covariates enables the system 300 to capture relationships between broader market conditions and order patterns, leading to more accurate predictions of order counts.

Using the techniques disclosed above, the order count forecasting sub-module 306a may be used to provide accurate predictions of the number of orders the warehouse can expect to handle on a daily basis.

The forecasting module 306 includes an itemset identification forecasting sub-module 306d, which implements step R1—the forecasting process that predicts the itemset which is a collection of item IDs that may occur in an order for a particular time period. The itemset identification forecasting sub-module 306d receives the predicted ordercount data 328 as input along with the historical data and produces the predicted itemset identification data 330 as output (FIG. 4, operation 404d). The time period may, for example, be a day, a week, a month, a quarter, or any other suitable time interval.

This sub-module 306d plays a valuable role within the forecasting module 306 by focusing specifically on predicting which particular items occur in each order on a periodic (e.g., daily) basis so that the warehouse can expect to prioritize them. By leveraging the predicted unique item count data 328 generated by the unique item forecasting sub-module 306c, the item identification forecasting sub-module 306d can provide a comprehensive forecast of the specific items expected to be in demand.

The predicted item identification data 330 produced by this sub-module 306d is valuable for various aspects of warehouse management and operations planning. It enables warehouse managers to anticipate and prepare for the specific items that will be needed, allowing for more precise inventory management, targeted restocking, and optimized picking strategies.

By providing detailed forecasts at the individual item level, the sub-module 306d contributes to the system 300's ability to generate highly specific and actionable insights that drive efficient, responsive warehouse operations. This capability aligns with the overall goal of the forecasting module 306 to provide comprehensive predictions that address the specific needs of modern warehouse operations, going beyond traditional planning engines that focus primarily on calculating aggregate demand for SKUs.

More specifically, the itemset identification forecasting sub-module 306d may operate using a weighted temporal sampling approach to predict the item IDs for a given time period. The time period may, for example, be a day, a week, a month, a quarter, or any other suitable time interval. The process uses a weighting system for both years and months, where more recent time periods are assigned higher weights to favor sampling from recent orders that better reflect current trends. The process works as follows:
First, the sub-module 306d selects a specific longer time period (e.g., month, quarter, or year) for sampling using the generated weights, with more recent time periods having higher probabilities of selection.
After year selection, the sub-module creates a bin of past transactions around the current date of the sampled time period. This bin is constructed using a specified sampling window that provides sufficient historical context while maintaining relevance to the current prediction date. The sampling window size may be optimized through hyperparameter tuning to balance having sufficient historical data while maintaining temporal relevance.
For each bin, the sub-module 306d:
   Assigns probabilities to each item set based on its frequency, forming a Probability Mass Function (PMF). This initial PMF represents a baseline probability distribution for sampling item sets from the bin.
   Dynamically adjusts the PMF by comparing economic indicators (such as exchange rates and inflation levels) between the forecast time period and transaction dates within the bin. When current economic conditions closely match those of a past transaction date, that transaction item's item set receives additional weight in the PMF. This allows the system to prioritize item sets from the periods with similar economic contexts.
   Adjusts sampling weights to give higher priority to transactions that occurred under economic conditions similar to the forecast time period, making it more likely to sample item sets that are relevant to both recent trends and the current economic environment. The economic factors considered may include, for example, credit availability metrics, exchange rate variations, and inflation rate comparisons.
The sampling process continues iteratively:
   First, probable item sets are sampled for the forecast time period, with each selected itemset being removed from the pool before sampling the next itemset to ensure unique predictions and prevent duplicate selections. The number of iterations may be the number of times predicted by R0 (the forecasted order count) for a given time period.
   Second, for each selected item, a quantity PMF is generated based on the historical quantities ordered on similar past dates. This quantity PMF reflects the frequency distribution of different order sizes for that specific item, allowing the model to predict realistic quantities.
   The quantity PMFs are dynamically adjusted based on economic similarities between the forecast time period and historical transaction dates. When the forecast time period's economic indicators (such as credit availability, exchange rates, and inflation) closely match those of a past transaction date, that transaction's ordered quantities receive higher weights in the PMF. This ensures sampled quantities align with both historical patterns and current economic conditions.

This weighted temporal sampling approach, combined with economic factor integration, allows the itemset identification forecasting sub-module 306d to generate predictions that are both historically informed and adaptable to recent trends. By using weighted temporal sampling, the sub-module can prioritize more recent data while still considering longer-term patterns.

The output of this sub-module 306d, the predicted itemset identification data 330, provides warehouse managers with specific information about which items are likely to be in demand during a given time period. This level of detail enables more precise inventory management, targeted restocking, and optimized picking strategies, contributing to more efficient and responsive warehouse operations.

The forecasting module 306 includes an item quantity forecasting sub-module 306e, which implements step R2—the forecasting process that predicts the item quantities for each predicted itemset for a time period. The item quantity forecasting sub-module 306e receives the predicted itemset identification data 330 as input and produces the predicted item quantity data 332 as output (FIG. 4, operation 404e). The time period may, for example, be a day, a week, a month, a quarter, or any other suitable time interval.

This sub-module 306e plays a valuable role within the forecasting module 306 by focusing specifically on predicting the quantities of each item in an order that the warehouse can expect to handle during a given time period. By leveraging the predicted itemset identification data 330 generated by the itemset identification forecasting sub-module 306d, the item quantity forecasting sub-module 306e can provide a comprehensive forecast of the expected quantities for each specific item in demand.

The predicted item quantity data 332 produced by this sub-module is valuable for various aspects of warehouse management and operations planning. The predicted item quantity data 332 enables warehouse managers to anticipate and prepare for the specific quantities of each item that will be needed, allowing for more precise inventory management, targeted restocking, and optimized storage strategies.

By providing detailed forecasts at the individual item quantity level, the sub-module 306e contributes to the system 300's ability to generate highly specific and actionable insights that drive efficient, responsive warehouse operations. This capability aligns with the overall goal of the forecasting module 306 to provide comprehensive predictions that address the specific needs of modern warehouse operations, going beyond traditional planning engines that focus primarily on calculating aggregate demand for SKUs.

More specifically, the item quantity forecasting sub-module 306e may operate using a method similar to the weighted temporal sampling approach used in R3. The process may work as follows:
Time Period Selection: Similar to R1, a time period is sampled from which the bins are to be created. The time period may, for example, be a year, quarter, month, or any other suitable time interval. This process uses the same bin from which itemsets were sampled for R1, ensuring consistency in the historical context.
Item Filtering: For each predicted item in an itemset, the sub-module 306e:
   Filters the rows containing that specific sampled item from the selected time period's data.
   Constructs a Probability Mass Function (PMF) using the transaction quantities of the particular item in an itemset. The PMF represents the probability distribution of different quantity values for that item based on historical data.
   Modifies the PMF to account for similarities between the current day's economic factors and those present in the sampling bin. Such similarity calculations may consider, for example, credit availability metrics, exchange rate variations, inflation rate comparisons, and/or other relevant economic indicators present in both current and historical data.
Iteration: This process is repeated for all the items in the item set predicted for a particular day. By using PMFs and economic factor similarities, the sub-module 306e may generate quantity predictions that are both historically informed and responsive to current market conditions.

By using this approach, the item quantity forecasting sub-module 306e can generate quantity predictions that are historically informed and consistent with the itemset identification predictions from sub-module 306d. The use of PMFs allows the sub-module 306e to capture the variability in order quantities for each item, providing a more nuanced forecast than a simple average or point estimate.

The system's hyperparameter tuning process may optimize several parameters that affect sampling accuracy, such as any one or more of the following:
Sampling window size: This parameter controls how many days before and after a given date are included when creating bins of past transactions. The optimal window size balances having sufficient historical data while maintaining relevance to the current prediction date.
Temporal weights: The system tunes the weights assigned to different years and months, typically favoring more recent periods to better reflect current trends.
Economic similarity parameters: The tuning process optimizes how economic factor similarities modify the sampling probabilities, affecting both item set selection and quantity determination.
Bootstrap sample size: The hyperparameter tuning may optimize the number of bootstrap samples generated for residual component forecasting, balancing computational efficiency with prediction accuracy. For example, the system 300 may tune parameters to determine whether to generate hundreds, thousands, or tens of thousands of bootstrap samples based on the specific dataset characteristics and accuracy requirements.
Model selection thresholds: The tuning process may optimize the error metric thresholds used to select among different forecasting models, such as Auto ARIMA, Auto Gluon, Prophet, and Neural Prophet. These thresholds determine when one model combination is considered sufficiently better than another to warrant selection.
Probability mass function smoothing parameters: The hyperparameter tuning may optimize smoothing factors applied to PMFs to handle sparse data conditions where certain item-quantity combinations have limited historical occurrences. These parameters help balance between historical accuracy and prediction robustness.
Seasonal decomposition parameters: The tuning process may optimize parameters for STL decomposition, including the seasonal window size, trend window size, and the number of iterations used in the decomposition process. These parameters affect how effectively the system 300 separates trend, seasonal, and residual components.
Economic indicator lag parameters: The hyperparameter tuning may optimize the time delays applied to economic indicators to capture their delayed effects on order patterns. For example, the system 300 may tune parameters to determine whether credit availability changes affect orders with a lag of one day, one week, or one month.
Cross-validation fold parameters: The tuning process may optimize the number of folds and the validation strategy used for model evaluation, including time-series specific cross-validation approaches that respect temporal ordering of the data.
Outlier detection sensitivity: The hyperparameter tuning may optimize the sensitivity parameters for outlier detection algorithms, determining how aggressively the preprocessing module 304 identifies and handles anomalous data points that could skew forecasting results.

The hyperparameter tuning ensures that the PMF modifications based on economic factors are optimally calibrated for both item set sampling and quantity prediction. This optimization process helps maintain the balance between historical patterns and current economic conditions in the final predictions.

The output of this sub-module 306e, the predicted item quantity data 332, provides warehouse managers with specific information about not only which items are likely to be in demand on a given day, but also in what quantities. This level of detail enables more precise inventory management, targeted restocking, and optimized storage strategies, contributing to more efficient and responsive warehouse operations.

The system 300 includes an order book generation module 310, which receives all of the outputs of the sub-modules 306a-e of the forecasting module 306 (i.e., the predicted order count data 324, the predicted itemset identification data 330, and the predicted item quantity data 332) and processes those outputs to generate the predicted order book data 322 (FIG. 4, operation 406).

The predicted order book data 322 may, for example, represent a comprehensive order book that may include, for example, any one or more of the following:
The number of orders per day, which may include both unique order identifiers and total order counts to distinguish between individual orders and order line items
The specific combinations of items in each order, including item identifiers, SKU-UoM combinations, and product categories that reflect historical ordering patterns and seasonal variations
The ordered quantities for each item in an order, which may be determined through probability mass function sampling that accounts for economic indicators and historical quantity distributions
Temporal ordering information that specifies the expected timing of orders throughout the forecasting period, enabling warehouse managers to anticipate peak demand periods and resource allocation requirements
Order complexity metrics that indicate the number of distinct items per order, facilitating picking route optimization and labor planning decisions
Item frequency rankings that identify which products are most likely to appear in orders during the forecasting period, supporting inventory positioning and slotting strategy decisions
Economic context indicators that correlate predicted orders with the economic conditions used in the forecasting models, providing insight into demand drivers and market sensitivity
Confidence intervals and uncertainty measures for each prediction component, enabling warehouse managers to assess forecast reliability and plan for potential variations in actual order patterns
Cross-references to historical order patterns that influenced the predictions, allowing for validation and adjustment of forecasting parameters based on actual performance
Any additional order details such as customer segmentation data, geographic distribution patterns, seasonal adjustment factors, and/or shipping requirements that may influence warehouse operations and resource planning

To generate the predicted order book data 322 based on the outputs of the sub-modules 306a-e, the order book generation module 310 may, for example, combine and process such outputs in any of a variety of ways to create a cohesive representation of expected orders. Such processing may include, for example, any one or more of the following:
Using the predicted order count data 324
Utilizing the predicted itemset identification data 330 and predicted item quantity data 332 to populate these orders with specific items and their quantities.
Applying additional logic and/or algorithms to ensure the generated orders are realistic and consistent with historical patterns.

In conclusion, the order book generation module 310 plays a valuable role in synthesizing the outputs from the various forecasting sub-modules 306a-e to create a comprehensive and realistic predicted order book. By integrating data on order counts, itemset identifications, and quantities, this module 310 generates a cohesive representation of expected orders that closely mirrors real-world warehouse operations. This sophisticated process enables warehouse managers to make informed decisions about inventory management, resource allocation, and operational strategies, ultimately leading to more efficient and responsive warehouse operations.

The predicted order book data 322 may take any of a variety of forms. For example, the predicted order book data 322 may include specific item identifiers paired with their forecasted quantities, representing the expected demand for individual products during a given forecasting period. In some cases, the predicted order book data 322 may contain entries, such as product codes with their associated unit of measure designations, where each entry specifies both the item identifier and the predicted quantity to be ordered. The predicted order book data 322 may reflect the temporal sampling and economic factor adjustments performed by the forecasting sub-modules 306a-e. In some cases, the same item identifier may appear multiple times in the predicted order book data 322 with different quantities, representing separate order instances that may occur during the forecasting period. This repetition pattern may result from the weighted temporal sampling approach, where items with higher historical frequency or favorable economic similarity scores receive multiple sampling opportunities, leading to more realistic order book predictions that account for both item popularity and market conditions. The order book generation module 310 may organize the predicted order book data 322 to include item identifiers that follow standardized naming conventions, such as alphanumeric codes that may incorporate product family designations, model numbers, and unit of measure suffixes. For example, the predicted order book data 322 may contain items with identifiers that include numeric sequences, alphabetic characters, and standardized suffixes that indicate the unit of measure, enabling warehouse management systems to process the forecasted data efficiently and integrate the predictions with existing inventory management workflows.

The system 300 may process various types of data to generate accurate forecasts. For example, the input data 302 may include historical order information organized by date, where each date entry contains multiple data fields that capture different aspects of warehouse operations. In some cases, the data may include temporal information such as picked date and time stamps that indicate when orders were processed, along with corresponding order count values that specify the number of orders handled on each particular date.

The input data 302 may include item-specific information that captures the diversity and complexity of orders processed by the warehouse. For example, the data may contain unique item count fields that indicate how many different products were involved in orders on a given date, along with detailed item quantity information that specifies the particular items ordered and their respective quantities. In some cases, this item quantity data may be structured as nested information that pairs specific item identifiers with their corresponding quantities, where item identifiers may follow standardized naming conventions that include product codes, model numbers, and unit of measure designations.

Economic indicator data may be integrated with the historical order information to provide broader market context for forecasting models. For example, the input data 302 may include credit availability metrics that reflect lending conditions during specific time periods, exchange rate information that captures currency fluctuations, and inflation rate data that indicates price level changes over time. In some cases, this economic data may be normalized to enable consistent comparison across different time periods, and may include derived metrics such as changes in economic indicators over time to capture trends and variations that may influence order patterns.

The data structure may also include additional derived fields that enhance the forecasting capabilities of the system 300. For example, the input data 302 may contain normalized versions of economic indicators that enable consistent scaling across different metrics, along with differential calculations that capture day-to-day changes in economic conditions. In some cases, the data may include identifier fields that enable tracking and correlation of information across different time periods and data sources, facilitating the integration of historical order patterns with economic context information that informs the forecasting models used by the various sub-modules 306a-e of the forecasting module 306.

The present disclosure provides a computer-implemented method for generating a predicted order book. The method includes preprocessing input data to produce preprocessed input data, and performing order book forecasting on the preprocessed input data to produce predicted order book data. The order book forecasting comprises forecasting a number of unique order IDs per day to produce predicted unique order count data, forecasting a total number of orders per day to produce predicted total order data, forecasting a number of unique item IDs per day to produce predicted unique item count data, forecasting item IDs for a day to produce predicted item identification data, and forecasting quantities of items for a day to produce predicted item quantity data. The method further includes generating, by an order book generation module, the predicted order book based on the predicted unique order count data, the predicted total order data, the predicted unique item count data, the predicted item identification data, and the predicted item quantity data.

In some embodiments, the input data comprises economic indicator data, and preprocessing the input data comprises integrating the economic indicator data with order history data by merging the economic indicator data according to corresponding date-time formats. The economic indicator data may comprise at least one of credit availability metrics, exchange rate data, and inflation rate data.

In certain embodiments, forecasting the number of unique order IDs per day comprises decomposing the preprocessed input data into trend, seasonality, and residual components using time series decomposition techniques. The forecasting may include forecasting the trend component using at least one of Auto ARIMA, Auto Gluon, Prophet, and Neural Prophet models, forecasting the seasonality component using cyclic picking techniques, and forecasting the residual component using probability distribution sampling of residuals.

In further embodiments, forecasting the number of unique order IDs per day includes generating predictions using multiple forecasting model combinations for the trend and seasonality components, evaluating performance of each model combination using Mean Absolute Percentage Error (MAPE) as an error metric, and selecting an optimal combination of models based on the MAPE results.

In some implementations, forecasting item IDs for a day comprises using a weighted temporal sampling approach that assigns higher weights to more recent time periods to favor sampling from recent orders that reflect current trends. The weighted temporal sampling approach may include selecting a specific year for sampling using generated weights with more recent years having higher probabilities of selection, creating a bin of past transactions around a current date of the sampled year using a specified sampling window, and assigning probabilities to each item set based on frequency to form a Probability Mass Function (PMF).

In certain embodiments, forecasting item IDs for a day further comprises dynamically adjusting the PMF by comparing economic indicators between a forecast day and transaction dates within the bin, wherein transactions with economic conditions similar to the forecast day receive additional weight in the PMF. The economic indicators used for PMF adjustment may comprise at least one of credit availability metrics, exchange rate variations, and inflation rate comparisons between the forecast day and historical transaction dates.

In some embodiments, forecasting quantities of items for a day comprises using a weighted temporal sampling approach that filters historical data for each predicted item and constructs Probability Mass Functions (PMFs) based on transaction quantities of specific items. The weighted temporal sampling approach may include selecting a year from which bins are created using the same bin from which itemsets were sampled, filtering rows containing each specific sampled item from the selected year's data, and constructing a PMF using transaction quantities of the particular item based on historical frequency patterns.

In further embodiments, forecasting quantities of items for a day includes modifying the PMF to account for similarities between current day economic factors and economic factors present in a sampling bin, wherein transactions with economic conditions similar to a forecast day receive higher weights in quantity determination. The economic factors used for PMF modification may comprise at least one of credit availability metrics, exchange rate variations, inflation rate comparisons, and labor economic indicators between the forecast day and historical transaction dates.

The present disclosure also provides a system comprising at least one non-transitory computer-readable medium having computer program instructions stored thereon, the computer program instructions being executable by at least one computer processor to perform the method described above. The system implements the same preprocessing, forecasting, and order book generation functionality as described connection with methods of embodiments of the present invention, including the time series decomposition techniques, weighted temporal sampling approaches, and economic indicator integration for enhanced forecasting accuracy.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically analyze data (such as sales history data) to generate the simulated order book 160, and then generating the slotting strategy 168 automatically based on the order book 160, among other inputs. Embodiments of the present invention may also automatically update the order book 160 and the slotting strategy 168 in response to changes in the warehouse, such as changes in the inventory of the warehouse. Such functions cannot be performed mentally or manually and are inherently rooted in computer technology.

As an additional example, the predictive engine that generates target allocations based on inputs such as sales history, demand forecasts, and supply chain plans is inherently rooted in computer technology. This engine utilizes algorithms and data processing techniques that require substantial computational power and storage capabilities, which are beyond the scope of manual calculations or mental estimations.

Additionally, the digital twin of the warehouse represents a significant improvement to computer technology. This virtual model may be dynamically updated in real-time to mirror the physical state of the warehouse, incorporating changes in inventory, layout modifications, and operational adjustments. The digital twin enables simulations and optimizations that transform the planning and operational strategies within the warehouse, effectively turning data into actionable insights and operational enhancements. This transformation of abstract data into a detailed, interactive model that can predict outcomes and influence real-world operations is a clear example of a feature that changes an entity into a different state or thing.

These features collectively highlight how embodiments of the invention leverage computer technology to address complex problems in warehouse management, offering solutions that are not feasible without the use of advanced computing techniques. Each component, from the predictive engine and digital twin to the implementation of sophisticated pathfinding algorithms, not only relies on but also advances computer technology, offering technological solutions to technological problems.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention utilize advanced time series decomposition techniques to analyze and forecast complex warehouse data. The forecasting module 306 (FIG. 3) decomposes time series data into multiple components (trend, seasonality, and residuals), allowing for targeted analysis and forecasting of each component. This level of sophisticated data processing and analysis is not feasible to perform manually, especially given the volume and complexity of warehouse data. The decomposition process may involve applying STL (Seasonal and Trend decomposition using LOESS) algorithms that require iterative mathematical computations across thousands or millions of data points, transforming raw historical order data into structured components that enable precise forecasting. The preprocessing module 304 may handle datasets containing years of historical transactions, economic indicators, and supply chain information, processing this data at speeds and scales that exceed human computational capabilities by orders of magnitude.

Embodiments of the present invention employ multiple advanced forecasting models simultaneously, such as Auto ARIMA, Auto Gluon, Prophet, and Neural Prophet, to generate predictions for trend and seasonality components. The order count forecasting sub-module 306a (FIG. 3) then automatically selects the best combination of models based on performance metrics like MAPE. This process of running multiple models in parallel and comparing their performance is computationally intensive and impractical to perform manually. The system 300 may execute hundreds of model combinations across different time horizons, evaluating each combination's accuracy against historical data to identify optimal forecasting approaches. The automated model selection process may involve complex statistical calculations, cross-validation procedures, and hyperparameter optimization that require substantial computational resources. The forecasting module 306 may process economic indicator data from multiple authoritative sources, including DNB, World Bank, IMF, and CBS, integrating this information with historical order patterns to create comprehensive forecasting models that account for broader market conditions affecting warehouse operations.

As another example, embodiments of the present invention implement automated machine learning techniques, such as those provided by Auto Gluon, to fit and select the best models for forecasting order counts. This automated model selection and optimization process requires significant computational power and is not feasible to perform manually. The system 300 may automatically test neural networks, gradient boosting models, linear regression variants, and ensemble methods, evaluating each approach's performance across different validation sets and time periods. The automated machine learning process may involve feature engineering, where the system 300 creates derived variables from raw data, such as rolling averages, seasonal indicators, and economic trend derivatives. The preprocessing module 304 may generate thousands of potential features from the input data 302, automatically selecting the most predictive combinations for each forecasting task. This feature selection process may involve statistical significance testing, correlation analysis, and predictive power assessment that would be impractical to perform manually given the scale and complexity of the data relationships.

As yet another example, embodiments of the present invention perform weighted temporal sampling on large datasets to predict item IDs and quantities for each day. The item identification forecasting sub-module 306d and item quantity forecasting sub-module 306e (FIG. 3) implement this process, which involves complex probability calculations and iterative sampling procedures that are computationally intensive and impractical to perform manually, especially when dealing with the large volumes of data typical in warehouse management. The weighted temporal sampling approach may create probability mass functions for thousands of different items, adjusting these probabilities based on economic similarity scores between current conditions and historical transaction dates. The system 300 may process millions of historical transactions, calculating similarity metrics across multiple economic indicators and temporal factors to generate accurate probability distributions. The sampling process may involve Monte Carlo simulations, bootstrap resampling techniques, and dynamic probability adjustments that require real-time computational processing. The item quantity forecasting sub-module 306e may generate thousands of bootstrap samples for residual component forecasting, averaging these samples to reduce variance and improve prediction accuracy through statistical techniques that are computationally demanding.

As yet a further example, embodiments of the present invention generate comprehensive order book predictions by integrating outputs from multiple forecasting sub-modules, each focusing on different aspects of the order data (e.g., order count, item IDs, and item quantities). The order book generation module 310 (FIG. 3) implements this integration process, which requires processing and combining large amounts of data in real-time, which is not feasible to perform manually. The order book generation module 310 may synthesize predicted unique order count data 324, predicted total order data 326, predicted unique item count data 328, predicted item identification data 330, and predicted item quantity data 332 into a cohesive predicted order book data 322 that maintains consistency across all forecasting dimensions. This integration process may involve complex data validation routines, consistency checks between different prediction components, and algorithmic reconciliation of potentially conflicting forecasts from different sub-modules. The system 300 may generate confidence intervals and uncertainty measures for each prediction component, enabling warehouse managers to assess forecast reliability through statistical calculations that require sophisticated mathematical processing. The order book generation module 310 may create temporal ordering information, order complexity metrics, and item frequency rankings that involve extensive data manipulation and statistical analysis across multiple dimensions of the forecasting output.

As an additional example, embodiments of the present invention continuously update and refine forecasts based on new data and feedback, allowing for dynamic adaptation to changing warehouse conditions and order patterns. This constant processing and updating of forecasts require real-time data handling and analysis capabilities that are only possible with computer systems. The system 300 may implement hyperparameter tuning processes that automatically optimize sampling window sizes, temporal weights, economic similarity parameters, and model selection thresholds based on ongoing performance evaluation. The continuous learning process may involve retraining forecasting models as new data becomes available, adjusting probability mass functions based on recent transaction patterns, and updating economic indicator correlations to reflect changing market conditions. The system 300 may process streaming data from warehouse management systems, economic databases, and supply chain platforms, integrating this information in real-time to maintain forecast accuracy. The dynamic adaptation process may involve complex feedback loops between the forecasting system 300 and integrated slotting systems, where actual fulfillment performance data informs both forecasting model refinements and slotting strategy adjustments through automated learning algorithms.

These features collectively transform raw warehouse data into actionable insights, enabling more efficient and responsive warehouse operations. The complexity, speed, and scale at which these processes operate make them inherently rooted in computer technology and impossible to implement through mental processes or manual calculations. The system 300 may process terabytes of historical data, economic indicators, and operational metrics to generate granular forecasts at the SKU-UoM level, providing unprecedented detail for warehouse management decisions. The transformation process may involve sophisticated data mining techniques, pattern recognition algorithms, and predictive modeling approaches that extract meaningful relationships from seemingly random warehouse data. Embodiments of the present invention may enable warehouses to transition from reactive to proactive operations by providing detailed predictions of future order compositions, quantities, and timing that inform inventory management, labor allocation, and slotting strategies. The technological solution addresses the inherent complexity and variability of warehouse operations through computational methods that continuously analyze, learn from, and adapt to changing operational conditions and market dynamics.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A computer-implemented method for generating a predicted order book, the method comprising:
(A) preprocessing input data to produce preprocessed input data;
(B) performing order book forecasting on the preprocessed input data to produce predicted order book data, wherein performing order book forecasting comprises:
(B)(1) forecasting a number of unique order IDs per day to produce predicted unique order count data;
(B)(2) forecasting a total number of orders per day to produce predicted total order data;
(B)(3) forecasting a number of unique item IDs per day to produce predicted unique item count data;
(B)(4) forecasting item IDs for a day to produce predicted item identification data; and
(B)(5) forecasting quantities of items for a day to produce predicted item quantity data; and
(C) generating, by an order book generation module, the predicted order book based on the predicted unique order count data, the predicted total order data, the predicted unique item count data, the predicted item identification data, and the predicted item quantity data.

2. The method of claim 1, wherein the input data comprises economic indicator data, and wherein preprocessing the input data comprises integrating the economic indicator data with order history data by merging the economic indicator data according to corresponding date-time formats.

3. The method of claim 2, wherein the economic indicator data comprises at least one of credit availability metrics, exchange rate data, and inflation rate data.

4. The method of claim 1, wherein forecasting the number of unique order IDs per day comprises decomposing the preprocessed input data into trend, seasonality, and residual components using time series decomposition techniques.

5. The method of claim 4, wherein forecasting the number of unique order IDs per day comprises:
forecasting the trend component using at least one of AutoARIMA, Auto Gluon, Prophet, and Neural Prophet models;
forecasting the seasonality component using cyclic picking techniques; and
forecasting the residual component using probability distribution sampling of residuals.

6. The method of claim 5, wherein forecasting the number of unique order IDs per day further comprises:
generating predictions using multiple forecasting model combinations for the trend and seasonality components;
evaluating performance of each model combination using Mean Absolute Percentage Error (MAPE) as an error metric; and
selecting an optimal combination of models based on the MAPE results.

7. The method of claim 1, wherein forecasting item IDs for a day comprises using a weighted temporal sampling approach that assigns higher weights to more recent time periods to favor sampling from recent orders that reflect current trends.

8. The method of claim 7, wherein the weighted temporal sampling approach comprises:
selecting a specific year for sampling using generated weights with more recent years having higher probabilities of selection;
creating a bin of past transactions around a current date of the sampled year using a specified sampling window; and
assigning probabilities to each item set based on frequency to form a Probability Mass Function (PMF).

9. The method of claim 8, wherein forecasting item IDs for a day further comprises dynamically adjusting the PMF by comparing economic indicators between a forecast day and transaction dates within the bin, wherein transactions with economic conditions similar to the forecast day receive additional weight in the PMF.

10. The method of claim 9, wherein the economic indicators used for PMF adjustment comprise at least one of credit availability metrics, exchange rate variations, and inflation rate comparisons between the forecast day and historical transaction dates.

11. The method of claim 1, wherein forecasting quantities of items for a day comprises using a weighted temporal sampling approach that filters historical data for each predicted item and constructs Probability Mass Functions (PMFs) based on transaction quantities of specific items.

12. The method of claim 11, wherein the weighted temporal sampling approach comprises:
selecting a year from which bins are created using the same bin from which itemsets were sampled;
filtering rows containing each specific sampled item from the selected year's data; and
constructing a PMF using transaction quantities of the particular item based on historical frequency patterns.

13. The method of claim 12, wherein forecasting quantities of items for a day further comprises modifying the PMF to account for similarities between current day economic factors and economic factors present in a sampling bin, wherein transactions with economic conditions similar to a forecast day receive higher weights in quantity determination.

14. The method of claim 13, wherein the economic factors used for PMF modification comprise at least one of credit availability metrics, exchange rate variations, inflation rate comparisons, and labor economic indicators between the forecast day and historical transaction dates.

15. A system comprising at least one non-transitory computer-readable medium having computer program instructions stored thereon, the computer program instructions being executable by at least one computer processor to perform a method, the method comprising:
(A) preprocessing input data to produce preprocessed input data;
(B) performing order book forecasting on the preprocessed input data to produce predicted order book data, wherein performing order book forecasting comprises:
(B)(1) forecasting a number of unique order IDs per day to produce predicted unique order count data;
(B)(2) forecasting a total number of orders per day to produce predicted total order data;
(B)(3) forecasting a number of unique item IDs per day to produce predicted unique item count data;
(B)(4) forecasting item IDs for a day to produce predicted item identification data; and
(B)(5) forecasting quantities of items for a day to produce predicted item quantity data; and
(C) generating, by an order book generation module, the predicted order book based on the predicted unique order count data, the predicted total order data, the predicted unique item count data, the predicted item identification data, and the predicted item quantity data.

16. The system of claim 15, wherein forecasting the number of unique order IDs per day comprises decomposing the preprocessed input data into trend, seasonality, and residual components using time series decomposition techniques.

17. The system of claim 16, wherein forecasting the number of unique order IDs per day further comprises:
generating predictions using multiple forecasting model combinations for the trend and seasonality components;
evaluating performance of each model combination using Mean Absolute Percentage Error (MAPE) as an error metric; and
selecting an optimal combination of models based on the MAPE results.

18. The system of claim 15, wherein forecasting item IDs for a day further comprises dynamically adjusting the PMF by comparing economic indicators between a forecast day and transaction dates within the bin, wherein transactions with economic conditions similar to the forecast day receive additional weight in the PMF.

19. The system of claim 18, wherein the economic indicators used for PMF adjustment comprise at least one of credit availability metrics, exchange rate variations, and inflation rate comparisons between the forecast day and historical transaction dates.

20. The system of claim 15, wherein forecasting quantities of items for a day comprises using a weighted temporal sampling approach that filters historical data for each predicted item and constructs Probability Mass Functions (PMFs) based on transaction quantities of specific items.

21. The system of claim 20, wherein the weighted temporal sampling approach comprises:
selecting a year from which bins are created using the same bin from which itemsets were sampled;
filtering rows containing each specific sampled item from the selected year's data; and
constructing a PMF using transaction quantities of the particular item based on historical frequency patterns.

22. The system of claim 21, wherein forecasting quantities of items for a day further comprises modifying the PMF to account for similarities between current day economic factors and economic factors present in a sampling bin, wherein transactions with economic conditions similar to a forecast day receive higher weights in quantity determination.
